(19) United States
(12) Patent Application Publication
(10) Pub. No.: US 2025/0289730 A1
(43) Pub. Date: Sep. 18, 2025

(54) CATION-DISORDERED CATHODE MATERIALS FOR STABLE LITHIUM-ION BATTERIES

(71) Applicant: VIRGINIA TECH INTELLECTUAL PROPERTIES, INC., Blacksburg, VA (US)

(72) Inventors: Feng LIN, Christiansburg, VA (US); Xuerong ZHENG, Tianjin (CN)

(21) Appl. No.: 18/842,304

(22) PCT Filed: Feb. 28, 2023
(86) PCT No.: PCT/US2023/014190

§ 371 Date: Aug. 28, 2024

Related U.S. Application Data
(60) Provisional application No. 63/314,934, filed on Feb. 28, 2022.

(51) Int. Cl. C01G 45/1228

(52) U.S. Cl. CPC C01G 45/1228; C01P 2002/02; C01P 2002/72; C01P 2002/76; C01P 2004/04; C01P 2004/61; C01P 2004/62; C01P 2004/64; C01P 2006/40

(57) ABSTRACT

A Group I metal cation excess cathode material comprising a Group I metal cation, at least two different non-Group I metal cations, and at least one counterion is disclosed. It is disclosed that the Group I metal cation excess cathode material delivers high capacity, rate capability, as well as long cycle life upon extensive 1,000 cycles at various current densities.

### STATEMENT REGARDING FEDERALLY SPONSORED RESEARCH OR DEVELOPMENT

This invention was made with government support under award DMR-2045570 awarded by the National Science Foundation. The government has certain rights in the invention.

### BACKGROUND

The recent progress of disordered rocksalt chemistry has unlocked a vast chemical space for designing high capacity cathode materials, such as Li₂Ni_{1/3}Ru_{2/3}O₃ [1], Li_{1.15}Ni_{0.45}Ti_{0.3}Mo_{0.1}O_{1.85}F_{0.15} [2], Li_{4/3}Mo_{2/3}O₂ [3], Li_{1.25}Nb_{0.25}Mn_{0.5}O₂ [4], Li_{1.3}Nb_{0.3}V_{0.4}O₂ [5], and Li_{1.171}Mn_{0.343}V_{0.486}O₂ [6] Li-excess disordered rocksalt oxides, and their fluorinated variants [6-11]. These materials can easily deliver material-level specific capacity and energy above 230 mAh g⁻¹ and 700 Wh Kg⁻¹, respectively, which are at the upper bound of conventional stoichiometric layered oxide cathodes. The percolation theory, proposed to explain the electrochemical properties of these disordered rocksalt cathode (DRX) materials, suggests that the Li-excess environments in DRX enable efficient Li ion transport in three-dimensional (3D) percolating pathways [12-14]. Ten percent (10%) Li excess is a minimal prerequisite to form percolation networks to ensure efficient Li⁺ migration in 3D channels [12,15]. Many DRX materials usually have high-valent transition metals (TMs) as charge compensators, such as Ti⁴⁺, Zr⁴⁺, Nb⁵⁺, V⁵⁺, and Mo⁶⁺, which are redox inactive species and are difficult to be reduced or oxidized during electrochemical cycling [16-23]. Thus, the high-valent charge compensators inevitably reduce the redox active transition metal content in DRX compounds [19,24]. Therefore, one key aspect for designing DRX materials is to maximize the redox active TM content and thus its contribution to the overall capacity, without relying much on the anionic redox activity.

Another key aspect for developing DRX materials is to improve cycle life, which represents a critical step towards their large-scale applications. To date, almost all the reported DRX materials are hindered by the inferior cycling stability [25]. For example, Li₂VO₂F can deliver a high specific capacity of over 400 mAh g⁻¹ and a specific energy of 1080 Wh kg⁻¹ at C/60 and 1.3-4.1 V vs Li/Li⁺ [26]. Li₄Mn₂O₅ can provide 355 mAh g⁻¹ specific capacity and 953 Wh kg⁻¹ specific energy at 25 mA g⁻¹ and 1.2-4.8 V vs Li/Li⁺ [27]. However, the capacity retention for Li₂VO₂F and Li₄Mn₂O₅ are only 70.4% after 8 cycles and 60% after 13 cycles, respectively [26,27]. Most recently, Li₂Mn_{0.67}Nb_{0.33}O₂F and Li₂Mn_{0.5}Ti_{0.5}O₂F were reported to provide specific capacity over 300 mAh g⁻¹ at 20 mA g⁻¹ and 1.5-5.0 V vs Li/Li⁺. However, their capacity retention is about 60% after 25 cycles [13]. Li_{1.2}Mn_{0.6}Nb_{0.2}O_{1.9}F_{0.1} showed a 92.4% capacity retention after 20 cycles at 10 mA g⁻¹ and 1.5-4.8 V vs Li/Li⁺. Therefore, these pioneering studies have laid the foundation for expanding the chemical space of DRX materials [24]. Recent experimental and theoretical studies indicate that the inferior stability of DRX materials results from the deterioration of the 3D percolating network, possibly caused by irreversible oxygen redox and release, transition metal dissolution, and phase separation [28-31]. In Li-rich DRX oxides, Oxygen-2p orbitals in the Li—O—Li configuration cannot hybridize with transition metal d orbitals due to a large energy separation, thus the orphaned unhybridized Oxygen-2p states are susceptible to oxidation [32]. The oxygen loss can shrink the oxygen framework, accelerate the migration of under-coordinated transition metal ions, and create a cation-densified surface to undermine Li ion kinetics and degrade cycling performance [32-34]. Therefore, one may reduce the reliance on oxygen redox and focus on maximizing the transition metal redox activity to utilize high capacity characteristics of DRX cathodes without compromising cycle life.

Despite advances in cathode material research, there is still a problem to identify and synthesize compounds that are both potent, efficacious, cathode materials with acceptable cycle life. This problem, as well as other needs and problems, are met in whole or in part by the present disclosure.

### SUMMARY

In accordance with the purpose(s) of the present disclosure, as embodied and broadly described herein, the disclosure, in one aspect, relates to cathode materials methods of making same, electrochemical cells and batteries comprising same.

The present disclosure includes a Group I metal cation excess cathode material comprising a Group I metal cation, at least two different non-Group I metal cations, and at least one counterion; wherein at least one of the at least two different non-Group I metal cations has a redox reaction within a voltage window of about 1.5 V to about 5.0 V vs Li/Li⁺ when measured according to a Redox Potential Measurement Method described herein; wherein the cathode material has an original specific capacity measured according to a Specific Capacity Test, described herein, of about 100 mAh to about 300 mAh per g of the cathode material; and wherein a percentage of the original specific capacity attributable to the at least two different non-Group I metal cations as determined by the Specific Capacity Deconvolution Procedure is from about 50% to about 100%; and with the proviso that the material is not Li_{1.15}Ni_{0.45}Ti_{0.3}Mo_{0.1}O_{1.85}F_{0.15}. or Li_{1.2}Mn_{0.6}Nb_{0.2}O_{1.9}F_{0.1}.

The disclosure also includes a Group I metal cation excess salt cathode material of formula AᵥM_{w}¹Mₓ²O_{y}D_{z} in the uncharged state; wherein
A is a Group I metal;
where M¹ and M² are each different non-Group I metal cations;
where D is selected from the group consisting of Fl, Cl, and Br,
where v is a number from 0 to 3;
where w is a number from 0 to 2;
where x is a number from 0 to 2;
where y is a number from 1 to 2;
where z is a number from 0 to 2;
where v+q¹*w+q²*x=²*y+z; and
where q¹ and q² are the positive oxidation states of M¹ and M² respectively. The material of the formula does not include the compounds Li_{1.15}Ni_{0.45}Ti_{0.3}Mo_{0.1}O_{1.85}F_{0.15} or Li_{1.2}Mn_{0.6}Nb_{0.2}O_{1.9}F_{0.1}.

The disclosure also includes a Group I metal cation excess salt cathode material of formula AᵥM_{w}¹Mₓ²Mᵤ³O_{y}D_{z} in the uncharged state;
where A is a Group I metal;
where M¹ and M² and M³ are each different non-Group I metals;
where D is selected from the group consisting of Fl, Cl, and Br;
where v is a number from 0 to 3;
where w is a number from 0 to 2;
where x is a number from 0 to 2;
where u is a number from 0 to 2
where y is a number from 1 to 2;
where z is a number from 0 to 2;
where v+q¹-w+q²·x+q³·u=²*y+z;
where q¹ and q² and q³ are the positive oxidation states of M¹ and M² and M³ respectively.

The disclosure also includes electrochemical device comprising a cathode stack comprising a cathodic current collector and the Group I metal cation excess cathode material that is formed over at least a portion of the cathodic current collector.

The disclosure also includes a method of making the cathode material, the method comprising:
(i) combining a salt, an oxide, or a peroxide of a Group I metal cation, a salt an oxide and/or a peroxide of a first non-Group I metal, and a salt an oxide and/or a peroxide of a second non-Group I metal to prepare a precursor;
(ii) ball milling the precursor to form a powder;
(iii) combining the powder with a molar excess of a flux material to form a mixture;
(iv) heating the mixture to an elevated temperature relative to room temperature for a period of time sufficient to form a calcined powder comprising the cathode material.

The disclosure also includes a method of making a cathode, the method comprising
(i) dispersing a cathode material with a binder material in a suitable solvent to form a slurry;
(ii) casting the slurry onto a cathodic current collector; and
(iii) allowing the suitable solvent to evaporate to form the cathode.

In an aspect, the salt can be a salt acceptable in the process, for example, a halide salt, for example a chloride, fluoride, or bromide salt.

In an aspect, the first non-Group I metal is an oxide of the first non-Group I metal.

In an aspect, the first non-Group I metal is a peroxide of the first non-Group I metal.

In an aspect, the second non-Group I metal is an oxide of the second non-Group I metal.

In an aspect, the second non-Group I metal is an peroxide of the second non-Group I metal.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows a Synchrotron XRD pattern of Li₂Mn_{3/4}Cr_{1/4}O₂F according to the disclosure, where the X-ray wavelength is calibrated to Cu Kₐ. FIG. 1B shows a least square refinement of Li₂Mn_{3/4}Cr_{1/4}O₂F using X-ray PDF data with raw experimental data.

FIG. 1C shows an HRTEM image (e) and FFT pattern ((d) inset) of a crystalline nanodomain in the Li₂Mn_{3/4}Cr_{1/4}O₂F particles. FIG. 1D shows scanning transmission electron microscopy (STEM)-EDS elemental mapping of Mn, Cr, O, and F in Li₂Mn_{3/4}Cr_{1/4}O₂F, where all constituting elements are present in the same particle.

FIG. 2A shows the Cr and Mn K-edge hard XAS spectra in pristine Li₂Mn_{3/4}Cr_{1/4}O₂F, with reference spectra included for comparison (Cr³⁺: LaCrO₃, Cr⁴⁺: CrO₂, Cr⁵⁺: CaCr_{0.5}Fe_{0.5}O₃, Cr⁶⁺: CrO₃, Mn²⁺: MnO, Mn³⁺: Mn₂O₃, Mn⁴⁺: MnO₂.). The Cr³⁺, Cr⁴⁺ and Cr⁵⁺ are reference spectra respectively [38-40]. FIG. 2B shows the calculation of valence states of chromium using the edge energy determined by averaging the linear rising edge of hard XAS spectra, as described in the Experimental Method. [38-40]. FIG. 2C shows the calculation of valence states of manganese using the edge energy determined by averaging the linear rising edge of hard XAS spectra, as described in the Experimental Method. FIG. 2D shows the evolution of Cr and Mn K-edge hard XAS during redox mechanosynthesis of Li₂Mn_{3/4}Cr_{1/4}O₂F, where Cr and Mn undergo gradual reduction and oxidation, respectively.

FIG. 3A shows specific discharge capacity of Li₂Mn_{3/4}Cr_{1/4}O₂F half cells measured at 50, 200, 500 and 1000 mA g⁻¹ in 2.0-4.4 V vs. Li/Li⁺. FIG. 3B shows a corresponding specific energy of the same cells shown in FIG. 3A. FIG. 3C shows a voltage drop and jump at the second cycle of Li₂Mn_{3/4}Cr_{1/4}O₂F half cells as a function of current density; V_{HC} is the upper cutoff voltage of the cell (i.e., 4.4 V vs. Li/Li⁺); V_{HD} is the starting discharge voltage. The difference between the two, labeled as uppers shaded region, represents the voltage drop at the upper cutoff. V_{LD} is the lower cutoff voltage of the cell (i.e., 2.0 V vs. Li/Li⁺); Vic is the starting charging voltage. The difference between the two, labeled as the lower shaded region, represents the voltage jump at the lower cutoff. FIG. 3D shows Li ion diffusion coefficient in Li₂Mn_{3/4}Cr_{1/4}O₂F at different states of charge and discharge in the first cycle at 2.0-4.4 V vs. Li/Li⁺ determined by GITT. FIG. 3E shows the specific discharge capacity and FIG. 3F shows the specific discharge energy of OLCM@Li∥LMCOF full cells cycled at 50 and 200 mA g⁻¹ in 2.0-4.4 V vs. Li/Li⁺ at 22° C. FIG. 3G shows the charge-discharge profiles of the OLCM@Li∥LMCOF full cell cycled at 50 mA g⁻¹. FIG. 3H shows the rate capability performance of a OLCM@Li∥LMCOF full cell. For FIG. 3A-3H, the OLCM@Li is a pre-lithiated carbon anode, with 4.71 mAh cm⁻² Li loading in a carbon matrix.

FIG. 4A shows a charge-discharge profile of the operando Li₂Mn_{3/4}Cr_{1/4}O₂F half cell at 100 mA g⁻¹. FIG. 4B and FIG. 4C, respectively, show the operando hard XAS spectra of Mn and Cr, respectively, in Li₂Mn_{3/4}Cr_{1/4}O₂F during the initial cycle. The K-edge positions and valence states of FIG. 4D (Mn) and FIG. 4E (Cr) are calculated by averaging the linear rising edge of the hard XAS spectra. FIG. 4F shows the calculated contribution of the Mn and Cr redox to the specific capacity of the cathode material of the disclosure.

FIG. 5 shows the charge-discharge profiles of Li₂Mn_{2/3}V_{1/3}O₂F (LMVOF) cycled at 20 mA g⁻¹.

FIG. 6 shows the charge-discharge profiles of Li_{2.1}Mn_{0.75}Cr_{0.25}O_{2.05}F₁ cycled at 50 mA g 1 at 50 mA g⁻¹ for cycles 1-100.

FIG. 7 shows the charge-discharge profiles of Li_{2.2}Mn_{0.75}Cr_{0.25}O_{2.1}F₁ cycled at 50 mA g⁻¹ for cycles 1-100.

FIG. 8 shows the charge-discharge profiles of Li_{2.1} Mn_{0.667}Nb_{0.333}O_{2.05}F₁ cycled at 50 mA g⁻¹ for cycles 1-50.

FIG. 9 shows the charge-discharge profiles of Li_{2.1}Min_{0.667}Nbc_{0.333}O_{2.05}F₁ cycled at 50 mA g⁻¹ for cycles 1-50 at 0° C.

FIG. 10 shows the charge-discharge profiles of Li_{2.1} Mn_{0.5}Ti_{0.5}O_{2.05}F₁ cycled at 50 mA g 1 for cycles 1-100.

FIG. 11 shows the charge-discharge profiles of Li_{2.1}Mn_{0.5}Ti_{0.5}O_{2.05}F₁ cycled at 2400 mA g⁻¹ charging rate and 50 mA g⁻¹ discharging rate for cycles 1-100.

FIG. 12 shows the charge-discharge profiles of Li_{2.1}Mn_{0.45}Ti_{0.45}Al_{0.1}O_{2.05}F cycled at 66.7 mA g⁻¹ for cycles 1-500.

FIG. 13 shows the charge-discharge profiles of Li_{2.1} Mn_{0.45}Ti_{0.45}Fe_{0.1}O_{2.05}F cycled at 66.7 mA g⁻¹ for cycles 1-500.

FIG. 14 shows the charge-discharge profiles of Li_{1.75}Mn_{0.45}Ti_{0.45}Fe_{0.1}O₂F_{0.75} cycled at 66.7 mA g⁻¹ for cycles 1-100.

FIG. 15 shows the charge-discharge profiles of Li_{1.25}Mn_{0.45}Ti_{0.45}Fe_{0.1}O₂F_{0.25} cycled at 66.7 mA g⁻¹ for cycles 1-100.

FIG. 16A shows high-resolution synchrotron XRD patterns and FIG. 16B shows amplified high-resolution synchrotron XRD patterns of Li_{2.1}Mn_{0.667}Nb_{0.333}O_{2.05}F₁ (LMNOF) at different states of charge and discharge. FIG. 16C shows high-resolution synchrotron XRD patterns and FIG. 16D shows amplified high-resolution synchrotron XRD patterns of LMNOF at different states of charge and discharge, wherein the peak position shift for LMNOF (0.6°) is much larger than that for LMCOF (0.3°). FIG. 16E shows high-resolution synchrotron XRD patterns and FIG. 16F shows amplified high-resolution synchrotron XRD patterns of LMCOF with 60% capacity retention; and compared with that of the pristine LMCOF, showing that no phase separation took place.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

References and publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a refers to an amount that is sufficient to achieve the desired improvement in the property modulated by the formulation component, e.g. achieving the desired level of modulus. The specific level in terms of wt % in a composition required as an effective amount will depend upon a variety of factors.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere). Unless otherwise stated, all experiments

### Are Conducted at Room Temperature.

### Cathode Materials

In an aspect, there is provided a Group I metal cation excess cathode material including a Group I metal cation, at least two different non-Group I metal cations, and at least one counterion; wherein at least one of the at least two different non-Group I metal cations has a redox reaction within a voltage window of about 2.0 V to about 4.5 V vs Li/Li⁺ when measured according to the Redox Potential Measurement Method; wherein the cathode material has an original specific capacity measured according to the Specific Capacity Test of about 100 mAh to about 300 mAh per g of the cathode material; and wherein a percentage of the original specific capacity attributable to the at least two different non-Group I metal cations as determined by the Specific Capacity Deconvolution Procedure is from about 50% to about 100%; and with the proviso that the material is not Li_{1.15}Ni_{0.45}Ti_{0.3}Mo_{0.1}O_{1.85}F_{0.15}, or Li_{1.2}Mn_{0.6}Nb_{0.2}O_{1.9}F_{0.1}.

In an aspect, the Group I cation may be a Li cation, a Na cation, or a K cation, or combination thereof. In certain aspects, the Group I cation may be a Li cation and/or a Na cation.

The disclosure includes the Group I metal cation excess salt which has a composition according to the formula AᵥM_{w}¹Mₓ²O_{y}D_{z} in the uncharged state. The Group I metal cation excess salt may have a composition according to the formula AᵥM_{w}¹Mₓ²Mᵤ³O_{y}D_{z} in the uncharged state.

In these formulas, v may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, or about 3.0. In the forgoing numbers, v may fall in a range of numbers from one number to another. For example, v may be from about 2.1 to about 2.8.

In these formulas, w, x, u, and z are, independently selected from numbers of about 0.01, about 0.02, about 0.03, about 0.04, about 0.05, about 0.06, about 0.07, about 0.08, about 0.09, about 0.10, about 0.11, about 0.12, about 0.13, about 0.14, about 0.15, about 0.16, about 0.17, about 0.18, about 0.19, about 0.20, about 0.21, about 0.22, about 0.23, about 0.24, about 0.25, about 0.26, about 0.27, about 0.28, about 0.29, about 0.30, about 0.31, about 0.32, about 0.33, about 0.34, about 0.35, about 0.36, about 0.37, about 0.38, about 0.39, about 0.40, about 0.41, about 0.42, about 0.43, about 0.44, about 0.45, about 0.46, about 0.47, about 0.48, about 0.49, about 0.50, about 0.51, about 0.52, about 0.53, about 0.54, about 0.55, about 0.56, about 0.57, about 0.58, about 0.59, about 0.60, about 0.61, about 0.62, about 0.63, about 0.64, about 0.65, about 0.66, about 0.67, about 0.68, about 0.69, about 0.70, about 0.71, about 0.72, about 0.73, about 0.74, about 0.75, about 0.76, about 0.77, about 0.78, about 0.79, about 0.80, about 0.81, about 0.82, about 0.83, about 0.84, about 0.85, about 0.86, about 0.87, about 0.88, about 0.89, about 0.90, about 0.91, about 0.92, about 0.93, about 0.94, about 0.95, about 0.96, about 0.97, about 0.98, about 0.99, about 1.00, about 1.01, about 1.02, about 1.03, about 1.04, about 1.05, about 1.06, about 1.07, about 1.08, about 1.09, about 1.10, about 1.11, about 1.12, about 1.13, about 1.14, about 1.15, about 1.16, about 1.17, about 1.18, about 1.19, about 1.20, about 1.21, about 1.22, about 1.23, about 1.24, about 1.25, about 1.26, about 1.27, about 1.28, about 1.29, about 1.30, about 1.31, about 1.32, about 1.33, about 1.34, about 1.35, about 1.36, about 1.37, about 1.38, about 1.39, about 1.40, about 1.41, about 1.42, about 1.43, about 1.44, about 1.45, about 1.46, about 1.47, about 1.48, about 1.49, about 1.50, about 1.51, about 1.52, about 1.53, about 1.54, about 1.55, about 1.56, about 1.57, about 1.58, about 1.59, about 1.60, about 1.61, about 1.62, about 1.63, about 1.64, about 1.65, about 1.66, about 1.67, about 1.68, about 1.69, about 1.70, about 1.71, about 1.72, about 1.73, about 1.74, about 1.75, about 1.76, about 1.77, about 1.78, about 1.79, about 1.80, about 1.81, about 1.82, about 1.83, about 1.84, about 1.85, about 1.86, about 1.87, about 1.88, about 1.89, about 1.90, about 1.91, about 1.92, about 1.93, about 1.94, about 1.95, about 1.96, about 1.97, about 1.98, about 1.99, or about 2.00.

In the forgoing array of numbers, w, x, u, and z independent of one another, may fall in a range of numbers from one number to another. For example, w, x, u, and z may be, independently from one another, in range from about 1.11 to about 1.93.

In these formulas, y may be a number from about 1 to about 2, for example about 1.00, about 1.05, about 1.10, about 1.15, about 1.20, about 1.25, about 1.30, about 1.35, about 1.40, about 1.45, about 1.50, about 1.55, about 1.60, about 1.65, about 1.70, about 1.75, about 1.80, about 1.85, about 1.90, about 1.95, or about 2.0. In the forgoing array of numbers, y may fall in a range of numbers from one number to another. For example, y may be in a range from about 1.15 to about 1.75.

In an aspect, the non-Group I metal cations of the cathode material may be independently chosen from the group consisting of Sc, Ti, V, Cr, Mn, Fe, Co, Ni, Cu, Zn, Y, Zr, Nb, Mo, Tc, Ru, Rh, Ag, Cd, La, Ce, Hf, Ta, W, Re, Os, Ir, Pt, Au, Hg, Be, Mg, Ca, Sr. Ba, B, Al, Ga, In, Si, Ge, Sn, Pb, Sb, Bi, Se, and Te cations. In another aspect, the non-Group I metal cations of the cathode material may be independently chosen from the group consisting of Al, Sc, Ti, V, Cr, Mn, Fe, Co, Ni, Cu, Zn, Y, Zr, Nb, Mo, Tc, Ru, Rh, Ag, Cd, La, Ce, Hf, Ta, W, Re, Os, Ir, Pt, Au, and Hg cations. In another aspect, the non-Group I metal cations of the cathode material may be independently chosen from the group consisting of Al, W, Sc, Ti, V, Cr, Mn, Fe, Co, Ni, Cu, and Zn cations. In another aspect, the non-Group I metal cations of the cathode material may be independently chosen from the group consisting of Al, Ti, V, Cr, Mn, Nb, Cu, and Fe cations.

In an aspect, the at least one counterion is selected from the group consisting of halogen anions. In another aspect, the at least one counterion is selected from the group consisting of F—, CI—, and Br—. The at least one counterion F— is preferred.

In an aspect the cathode material is a disordered cubic crystal structure which refers to a type of crystal structure in which the atoms or ions are not arranged in a predictable or uniform way within the cubic lattice. In such a structure, the symmetry of the cubic lattice is broken due to the presence of defects, impurities, or other irregularities. These irregularities can occur at various length scales, ranging from local distortions of the crystal structure to large-scale rearrangements of the lattice. The term disordered cubic crystal structure, as used herein, does not extend to entirely amorphous materials that do not have an overall cubic lattice. The term disordered cubic crystal structure does extend, however, to (i) a crystal with point defects, such as vacancies or interstitials and (ii) to polycrystalline materials consisting of multiple disordered cubic crystals having larger-scale grain boundaries. Point defects are defects in the crystal lattice where an atom or ion is missing (a vacancy) or occupies an irregular position (an interstitial).

In an aspect, the cathode material is a disordered rocksalt crystal structure, particularly for materials comprising transition metal oxides and Group-I ions and may be a disordered cubic crystal structure which allows migration of Group-I ions between two group-I sites through an intermediate site in the crystal lattice.

In an aspect, the cathode material is a disordered spinel crystal structure, where the tetrahedral sites formed by anions are occupied by Group-I ions and non-Group I metal cations. In an aspect, the cathode material may include two different non-Group I metal cations independently selected from the group consisting of Sc, Ti, V, Cr, Mn, Fe, Co, Ni, Cu, Zn, Y, Zr, Nb, Mo, Tc, Ru, Rh, Ag, Cd, La, Ce, Hf, Ta, W, Re, Os, Ir, Pt, Au, Hg, Be, Mg, Ca, Sr, Ba, B, Al, Ga, In, Si, Ge, Sn, Pb, Sb, Bi, Se, and Te cations.

In an aspect, the cathode material may include three different non-Group I metal cations independently selected from the group consisting of Sc, Ti, V, Cr, Mn, Fe, Co, Ni, Cu, Zn, Y, Zr, Nb, Mo, Tc, Ru, Rh, Ag, Cd, La, Ce, Hf, Ta, W, Re, Os, Ir, Pt, Au, Hg, Be, Mg, Ca, Sr, Ba, B, Al, Ga, In, Si, Ge, Sn, Pb, Sb, Bi, Se, and Te cations.

In an aspect, the cathode material may include four different non-Group I metal cations independently selected from the group consisting of Sc, Ti, V, Cr, Mn, Fe, Co, Ni, Cu, Zn, Y, Zr, Nb, Mo, Tc, Ru, Rh, Ag, Cd, La, Ce, Hf, Ta, W, Re, Os, Ir, Pt, Au, Hg, Be, Mg, Ca, Sr, Ba, B, Al, Ga, In, Si, Ge, Sn, Pb, Sb, Bi, Se, and Te cations.

In an aspect, the cathode material may include five different non-Group I metal cations selected from the group consisting of Sc, Ti, V, Cr, Mn, Fe, Co, Ni, Cu, Zn, Y, Zr, Nb, Mo, Tc, Ru, Rh, Ag, Cd, La, Ce, Hf, Ta, W. Re, Os, Ir, Pt, Au, Hg, Be, Mg, Ca, Sr, Ba, B. Al, Ga, In, Si, Ge, Sn, Pb, Sb, Bi, Se, and Te cations.

In an aspect, the specific capacity of the cathode material measured according to the Specific Capacity Test wherein a number of cycles of the test may be from 10-5000, or from 10 to 4000, or from 10 to 3000, or from 10 to 2000, or from 10 to 1000, or from 100 to 200, or from 100 to 300, or from 200 to 400, or from 200-300, or from 300 to 500, or from 300 to 400, or from 400 to 600, or from 400 to 500, or from 500 to 700 or from 500 to 600, or from 600 to 800, or from 600 to 700, or from 700 to 900, or from 700 to 800, or from 800 to 1000 or from 800 to 900, or from 900 to 1100, or from 900 to 1000; or from 1000 to 1200, or from 1000 to 1100, or from 1100 to 1300, or from 1100 to 1200, or from 1200 to 1400, or from 1200 to 1300, or from 1300 to 1500, or from 1300 to 1400, or from 1400 to 1600, or from 1400 to 1500, or from 1500 to 1700 or from 1500 to 1600, or from 1600 to 1800, or from 1600 to 1700, or from 1700 to 1900, or from 1700 to 1800, or from 1800 to 2000 or from 1800 to 1900, or from 1900 to 2100, or from 1900 to 2000; or from 2000 to 2200, or from 2000 to 2100, or from 2100 to 2300, or from 2100 to 2200, or from 2200 to 2400, or from 2200 to 2300, or from 2300 to 2500, or from 2300 to 2400, or from 2400 to 2600, or from 2400 to 2500, or from 2500 to 2700 or from 2500 to 2600, or from 2600 to 2800, or from 2600 to 2700, or from 2700 to 2900, or from 2700 to 2800, or from 2800 to 3000 or from 2800 to 2900, or from 2900 to 3100, or from 2900 to 3000; or from 3000-3200, or from 3000 to 2100, or from 3100 to 3300, or from 3100 to 3200, or from 3200 to 3400, or from 3200-3300, or from 3300 to 3500, or from 3300 to 3400, or from 3400 to 3600, or from 3400 to 3500, or from 3500 to 3700 or from 3500 to 3600, or from 3600 to 3800, or from 3600 to 3700, or from 3700 to 3900, or from 3700 to 3800, or from 3800 to 4000 or from 3800 to 3900, or from 3900 to 3100, or from 3900 to 4000 or from or from 4000 to 4200, or from 4000 to 4100, or from 4100 to 4300, or from 4100 to 4200, or from 4200 to 4400, or from 4200-4300, or from 4300 to 4500, or from 4300 to 4400, or from 4400 to 4600, or from 4400 to 4500, or from 4500 to 4700 or from 4500 to 4600, or from 4600 to 4800, or from 4600 to 4700, or from 4700 to 4900, or from 4700 to 4800, or from 4800 to 5000 or from 4800 to 4900, or from 4900 to 5000 cycles.

In an aspect, the voltage window over which the specific capacity is measured from voltage A to voltage B wherein voltage A and voltage B are independently selected from the group consisting of positive numbers of about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, and about 5.0 volts wherein B>A.

In an aspect, the percentage of the original specific capacity attributable to the at least two different non-Group I metal cations as determined by the Specific Capacity Deconvolution Procedure is from about 50% to about 100%. In another aspect, the percentage of original specific capacity may be about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, or about 100 percent. In the forgoing array of numbers, the percentage of original capacity may comprise a range of percentages from one number to another. For example, the percentage of original specific capacity may be from about 52% to about 61%.

In an aspect, the original specific capacity of the cathode material may be about 100, about 110, about 120, about 130, about 140, about 150, about 160, about 170, about 180, about 190, about 200, about 210, about 220, about 230, about 240, about 250, about 260, about 270, about 280, about 290, or about 300 mAh/g. In the forgoing array of numbers, the original specific capacity may comprise a range of values from one number to another. For example, the original specific capacity may be from about 220 mAh/g to about 270 mAh/g.

In an aspect, the cathode material may comprise a single crystal average particle size as measured by a scanning electron microscope or a transmission electron microscope. The average single crystal particle size may be from about 1 nm to about 1000 nm, or from about 1 nm to about 500 nm, or from about 1 nm to about 250 nm, or from about 1 nm to about 100 nm, or from about 1 nm to about 5 nm to about 100 nm, or from about 5 nm to about 75 nm, or from about 5 nm to about 60 nm, or from about 5 nm to about 50 nm, or from about 5 nm to about 40 nm, or from about 5 nm to about 30 nm, or from about 5 nm to about 25 nm.

In an aspect, the cathode material may comprise a polycrystal, or a polycrystalline, average particle size as measured by a scanning electron microscope or a transmission electron microscope of from about 5 nm to about 5000 nm, or from about 5 nm to about 10000 nm, or from about 5 nm to about 100000 nm, or from about 10 nm to about 5000 nm, or from about 10 nm to about 5000 nm, or from about 20 nm to about 5000 nm, or from about 50 nm to about 5000 nm, or from about 100 nm to about 5000 nm, or from about 100 nm to about 5000 nm, or from about 100 nm to about 5000 nm, or from about 500 nm to about 5000 nm, or from about 1000 nm to about 5000 nm, or from about 2000 nm to about 5000 nm, or from about 3000 nm to about 5000, or from about 4000 nm to about 5000 nm

In various aspects, the average particle size is about 10, about 50, about 100, about 200, about 300, about 400, about 500, about 600, about 700, about 800, about 900, about 1000, about 1500, about 2000, about 2500, about 3000, or about 4000 nanometers.

### Electrochemical Device and Battery

In an aspect, the disclosure includes an electrochemical device comprising a cathode stack comprising a cathodic current collector and the Group I metal cation excess cathode material that is formed over at least a portion of the cathodic current collector. The current collector may be one that is known to a person of ordinary skill in the art. For example, the current collector may comprise aluminum, copper, nickel, titanium, a stainless steel. The current collector may be a shaped article, e.g., a foil, mesh, foam, etched and/or a carbon-coated-type collector.

In an aspect, the electrochemical device may comprise an anode stack comprising an anodic current collector and an anode material that is formed over at least a portion of the anodic current collector, a separator material between the cathode stack and the anode stack; and an electrolyte. The electrochemical device may be a battery. The anode material may be one known to a person of ordinary skill, for example, Graphite, Si, Li metal, Na metal, K metal, Sn, Graphite/Si composite, Graphite/Sn composite, Graphite/Li composite, Graphite/Na composite, Graphite/K composite, and hard carbon and/or a combination thereof.

The separator material may be one known to a person of ordinary skill in the art, for example, nonwoven fiber, a cotton fiber, a nylon, a polyester, a glass, a polymer film, a polyolefin, e.g., polyethylene, a polypropylene, a poly (tetrafluoroethylene), a polyvinyl chloride, a ceramic, a rubber, and an asbestos. The electrolyte may be solid or liquid, and comprising lithium, sodium, and/or potassium ions.

### Method of Preparation

In an aspect, the disclosure includes a method of preparing the cathode material, which includes combining a salt, an oxide, and/or a peroxide of a Group I metal, a salt, an oxide, and/or a peroxide of a first non-Group I metal, and a salt, an oxide, and/or a peroxide of a second non-Group I metal to prepare a precursor; ball milling the precursor to form a powder; combining the powder with a molar excess of a flux material to form a mixture; heating the mixture to an elevated temperature relative to room temperature for a period of time sufficient to form a calcined powder comprising the cathode material and optionally separating the cathode material from the flux material in the calcined powder.

In an aspect, the precursor may be ball milled for a period of time of from about 12 hours to about 72 hours, or from about 12 to about 48 hours, or from about 12 to about 36 hours, or from about 12 hours to about 36 hours, to form the material

In an aspect, the dry ball milling may be effected in a dry and/or inert atmosphere. For example, the ball milling may take place in an argon and/or nitrogen atmosphere. Typically, the ball size is selected by the person of ordinary skill to obtain the desired polycrystal or single crystal size.

In an aspect, the ball milling may be dry ball milling and/or wet ball milling. In an aspect, the method of preparation may include adding a stoichiometric excess of the Group I metal cation salt, for example, a 10%, 20%, 30%, 40% or higher stoichiometric excess.

In an aspect, the flux material may be LiCl, LINO₃, LiOH, LIF, Li₂SO₄, Li₂CO₃, CH₃C(O)OLi, NaCl, NaNO₃, NaOH, Na₂SO₄, Na₂CO₃, CH₃C(O)ONa, NaF, KCl, KNO₃, KOH, K₂SO₄, K₂CO₃, CH₃C(O)OK and/or KF.

In an aspect, the heating may take place from about 300° C. to about 1200° C., or from about 400° C. to about 1200° C., or from about 500° C. to about 1200° C., or from about 600° C. to about 1200° C., or from about 700° C. to about 1200° C., or from about 800° C. to about 1200° C., or from about 900° C. to about 1200° C., or from about 1000° C. to about 1200° C.

In an aspect, the heating, or increase in temperature, may be effected by heating at a rate of from of about 0.5° C./min to about 10° C./min, or from 1° C./min to about 10° C./min, or from about 2° C./min to about 10° C./min, or from about 3° C./min to about 10° C./min, or from about 4° C./min to about 10° C./min, or from about 5° C./min to about 10° C./min, or from about 6° C./min to about 10° C./min, or from about 7° C./min to about 10° C./min, or from about 8° C./min to about 10° C./min, or from about 9° C./min to about 10° C./min.

In an aspect, the w/w ratio of the flux to the metal cation salt may be selected as needed by the person of ordinary skill in the art. A ratio may be from about 1 to about 30, or from about 1 to about 40, or from about 1 to about 50, or from about 1 to about 60, or from about 1 to about 70, or from about 1 to about 80, or from about 1 to about 90, or from about 1 to about 100.

In an alternative aspect, the disclosure includes a method of making a cathode, the method comprising dispersing a cathode material with a binder material in a suitable solvent to form a slurry; casting the slurry onto a cathodic current collector; and allowing the suitable solvent to evaporate to form the cathode. Carbon black may be mixed into the slurry.

The binder may be selected from those known to those of ordinary skill in the art, for example, PVDF, CMC, PAA, and/or Cyrene.

The disclosure will be better understood by reading the following numbered aspects, which should not be confused with the claims. In some instances, one or more aspects may be combined or combined with aspects described elsewhere in the disclosure or aspects from the examples without deviating from the invention. The following listing of exemplary aspects supports and is supported by the disclosure provided.

Aspect 1. A Group I metal cation excess cathode material comprising a Group I metal cation, at least two different non-Group I metal cations, and at least one counterion;
wherein at least one of the at least two different non-Group I metal cations has a redox reaction within a voltage window of about 1.5 V to about 5.0 V vs Li/Li⁺ when measured according to the Redox Potential Measurement Method;
wherein the cathode material has an original specific capacity measured according to the Specific Capacity Test of about 100 mAh to about 300 mAh per g of the cathode material; and
wherein a percentage of the original specific capacity attributable to the at least two different non-Group I metal cations as determined by the Specific Capacity Deconvolution Procedure is from about 50% to about 100%; and
with the proviso that the material is not Li_{1.15}Ni_{0.45}Ti_{0.3}Mo_{0.1}O_{1.85}F_{0.15} or Li_{1.2}Mn_{0.6}Nb_{0.2}O_{1.9}F_{0.1}.

Aspect 2. The cathode material according to Aspect 1, wherein the Group I metal cation is selected from the group consisting of a Li cation, a Na cation, a K cation, and a combination thereof.

Aspect 3. The cathode material according to Aspect 1 or Aspect 2, wherein the Group-I metal cation is a Li cation.

Aspect 4. The cathode material according to any one of the foregoing aspects, wherein the at least two different non-Group I metal cations are each independently selected from the group consisting of Sc, Ti, V, Cr, Mn, Fe, Co, Ni, Cu, Zn, Y, Zr, Nb, Mo, Tc, Ru, Rh, Ag, Cd, La, Ce, Hf, Ta, W, Re, Os, Ir, Pt, Au, Hg, Be, Mg, Ca, Sr, Ba, B, Al, Ga, In, Si, Ge, Sn, Pb, Sb, Bi, Se, and Te cations.

Aspect 5. The cathode material according to any one of the foregoing aspects, wherein the at least two different non-Group I metal cations are each independently selected from the group consisting of Sc, Ti, V, Cr, Mn, Fe, Co, Ni, Cu, Zn, Y, Zr, Nb, Mo, Tc, Ru, Rh, Ag, Cd, La, Ce, Hf, Ta, W, Re, Os, Ir, Pt, Au, Hg, Be, Mg, Ca, Sr, Ba, B, Al, Ga, In, Si, Ge, Sn, Pb, Sb, Bi, Se, and Te.

Aspect 6. The cathode material according to any one of the foregoing aspects, wherein the at least two different non-Group I metal cations are each independently selected from the group consisting of Sc, Ti, V, Cr, Mn, Fe, Co, Ni, Cu, Zn, Y, Zr, Nb, Mo, Tc, Ru, Rh, Ag, Cd, La, Ce, Hf, Ta, W, Re, Os, Ir, Pt, Au, Hg, Be, Mg, Ca, Sr, Ba, B, Al, Ga, In, Si, Ge, Sn, Pb, Sb, Bi, Se, and Te cations.

Aspect 7. The cathode material according to any one of the foregoing aspects, wherein the Group I metal cation excess salt has a composition according to the formula AᵥM_{w}¹Mₓ²O_{y}D_{z} in the uncharged state;
where A is a Group I metal;
where M¹ and M² are each different non-Group I metal cations;
where D is selected from the group consisting of Fl, Cl, and Br;
where v is a number from 0 to 3;
where w is a number from 0 to 2;
where x is a number from 0 to 2;
where y is a number from 1 to 2;
where z is a number from 0 to 2;
where v+q¹·w+q² x=2·y+z;
where q¹ and q² are the positive oxidation states of M¹ and M² respectively.

Aspect 8. The cathode material according to any one of the foregoing aspects, wherein q¹ and q² are each +3.

Aspect 9. The cathode material according to any one of the foregoing aspects, wherein M¹ and M² are different and each independently selected from the group consisting of Sc, Ti, V, Cr, Mn, Fe, Co, Ni, Cu, Zn, Y, Zr, Nb, Mo, Tc, Ru, Rh, Ag, Cd, La, Ce, Hf, Ta, W, Re, Os, Ir, Pt, Au, Hg, Be, Mg, Ca, Sr, Ba, B, Al, Ga, In, Si, Ge, Sn, Pb, Sb, Bi, Se, and Te cations.

Aspect 10. The cathode material according to any one of the foregoing aspects, wherein the Group I metal cation excess salt has a composition according to the formula AᵥM_{w}¹Mₓ²Mᵤ³O_{y}D_{z} in the uncharged state;
where A is a Group I metal;
where M¹ and M² and M³ are each different non-Group I metals;
where D is selected from the group consisting of Fl, Cl, and Br;
where v is a number from 0 to 3;
where w is a number from 0 to 2;
where x is a number from 0 to 2;
where u is a number from 0 to 2
where y is a number from 1 to 2;
where z is a number from 0 to 2;
where v+q¹ w+q²x+q³·u=²·y+z; and
wherein q¹ and q² and q³ are the positive oxidation states of M¹ and M² and M³ respectively.

Aspect 11. The cathode material according to any one of the foregoing aspects, wherein q¹ and q² and q³ are each +3.

Aspect 12. The cathode material according to any one of the foregoing aspects, wherein M¹ and M² and M³ are different and each independently selected from the group consisting of Sc, Ti, V, Cr, Mn, Fe, Co, Ni, Cu, Zn, Y, Zr, Nb, Mo, Tc, Ru, Rh, Ag, Cd, La,
Ce, Hf, Ta, W, Re, Os, Ir, Pt, Au, Hg, Be, Mg, Ca, Sr, Ba, B, Al, Ga, In, Si, Ge, Sn, Pb, Sb, Bi, Se, and Te cations.

Aspect 13. The cathode material according to any one of the foregoing aspects, wherein the cathode material has a disordered cubic crystal structure.

Aspect 14. The cathode material according to any one of the foregoing aspects, wherein the cathode material has a disordered rocksalt crystal structure.

Aspect 15. The cathode material according to any one of the foregoing aspects, wherein the cathode material has a disordered spinel crystal structure.

Aspect 16. The cathode material according to any one of the foregoing aspects, wherein the cathode material has a specific capacity measured after a number of cycles that is from 60% to 90% of the original specific capacity when measured according to the Specific Capacity Test, and wherein the number of cycles is from 200 to 5,000 cycles.

Aspect 17. The cathode material according to any one of the foregoing aspects, wherein there is substantially no phase separation of the material as determined by X-ray diffraction after 1,000 charge-discharge cycles according to the Galvanostatic Cycling Test; wherein substantially no phase separation means the cubic lattice peak structure is maintained as measured by X-ray diffraction pattern wherein there is no new peak forming in the X-ray diffraction after the Galvanostatic Cycling Test.

Aspect 18. The cathode material according to any one of the foregoing aspects, wherein a percentage of the original specific capacity attributable to a reversible oxygen redox process is from 0% to 50%, or from 0% to 40%, or from 0% to 30%, or from 0% to 20%, or from 0% to 10%, as defined as the difference between the original specific capacity and a specific capacity of the non-Group I metal cations as measured by the Specific Capacity Deconvolution Procedure.

Aspect 19. The cathode material according to any one of the foregoing aspects, wherein the at least two different non-Group I metal cations are each independently selected from the group consisting of Al, Sc, Ti, V, Cr, Mn, Fe, Co, Ni, Cu, Zn, Y, Zr, Nb, Mo, Tc, Ru, Rh, Ag, Cd, La, Ce, Hf, Ta, W, Re, Os, Ir, Pt, Au, and Hg cations.

Aspect 20. The cathode material according to any one of the foregoing aspects, wherein the at least two different non-Group I metal cations are independently selected from the group consisting of AI, W, Sc, Ti, V, Cr, Mn, Fe, Co, Ni, Cu, and Zn cations.

Aspect 21. The cathode material according to any one of the foregoing aspects, wherein one of the at least two different non-Group I metal cations is a Cr cation.

Aspect 22. The cathode material according to any one of the foregoing aspects, wherein one of the at least two different non-Group I metal cations is a Mn cation.

Aspect 23. The cathode material according to any one of the foregoing aspects, wherein one of the at least two different non-Group I metal cations is a V cation.

Aspect 24. The cathode material according to any one of the foregoing aspects, wherein one of the at least two different non-Group I metal cations is an Al cation.

Aspect 25. The cathode material according to any one of the foregoing aspects, wherein one of the at least two different non-Group I metal cations is an Fe cation.

Aspect 26. The cathode material according to any one of the foregoing aspects, wherein one of the at least two different non-Group I metal cations is a Nb cation.

Aspect 27. The cathode material according to any one of the foregoing aspects, wherein two of the at least two different non-Group I metal cations are selected from the group consisting of Mn and Fe cations, Mn and V cations, Mn and Cr cations, Mn and Cu cations, Mn and W cations, Mn and Ni cations, and Mn and Co cations.

Aspect 28. The cathode material according to any one of the foregoing aspects, wherein two of the at least two different non-Group I metal cations are selected from the group consisting of Mn and Fe cations, Mn and V cations, Mn and Cr cations, Mn and Cu cations, and Mn and W cations.

Aspect 29. The cathode material according to any one of the foregoing aspects, wherein two of the at least two different non-Group I metal cations are selected from the group consisting of Fe and Co cations, Fe and Ni cations, Fe and Cu cations, Fe and W cations, and Fe and Cr cations.

Aspect 30. The cathode material according to any one of the foregoing aspects wherein two of the at least two different non-Group I metal cations are selected from the group consisting of Fe and Cu cations, Fe and W cations, and Fe and Cr cations.

Aspect 31. The cathode material according to any one of the foregoing aspects wherein two of the at least two different non-Group I metal cations are selected from the group consisting of Cu and W cations, Cu and Cr cations, and Cu and V cations.

Aspect 32. The cathode material according to any one of the foregoing aspects, wherein two of the at least two different non-Group I metal cations are selected from the group consisting of Cu and W cations, and Cu and Cr cations.

Aspect 33. The cathode material according to any one of the foregoing aspects, wherein two of the at least two different non-Group I metal cations are selected from the group consisting of Ti and V cations, Ti and Cr cations, Ti and Mn cations, Ti and Fe cations, Ti and Co cations, Ti and Ni cations, Ti and Cu cations, and Ti and W cations.

Aspect 34. The cathode material according to any one of the foregoing aspects, wherein two of the at least two different non-Group I metal cations are selected from the group consisting of Ti and Cr cations, Ti and Mn cations, Ti and Fe cations, Ti and Cu cations, and Ti and W cations.

Aspect 35. The cathode material according to any one of the foregoing aspects, wherein two of the at least two different non-Group I metal cations are selected from the group consisting of Mo and V cations, Mo and Cr cations, Mo and Mn cations, Mo and Fe cations, Mo and Co cations, Mo and Ni cations, Mo and Cu cations, and Mo and W cations.

Aspect 36. The cathode material according to any one of the foregoing aspects, wherein two of the at least two different non-Group I metal cations are selected from the group consisting of Mo and Cr cations, Mo and Mn cations, Mo and Fe cations, Mo and Cu cations, and Mo and W cations.

Aspect 37. The cathode material according to any one of the foregoing aspects, wherein two of the at least two different non-Group I metal cations are selected from the group consisting of Zr and V cations, Zr and Cr cations, Zr and Mn cations, Zr and Fe cations, Zr and Co cations, Zr and Ni cations, Zr and Cu cations, and Zr and W cations.

Aspect 38. The cathode material according to any one of the foregoing aspects, wherein two of the at least two different non-Group I metal cations are selected from the group consisting of Zr and Cr cations, Zr and Mn cations, Zr and Fe cations, Zr and Cu cations, and Zr and W cations.

Aspect 39. The cathode material according to any one of the foregoing aspects, wherein two of the at least two different non-Group I metal cations are selected from the group consisting of Nb and V cations, Nb and Cr cations, Nb and Mn cations, Nb and Fe cations, Nb and Co cations, Nb and N cations, Nb and Cu cations, and Nb and W cations.

Aspect 40. The cathode material according to any one of the foregoing aspects wherein two of the at least two different non-Group I metal cations are selected from the group consisting of Nb and Cr cations, Nb and Mn cations, Nb and Fe cations, Nb and Cu cations, and Nb and W cations.

Aspect 41. The cathode material according to any one of the foregoing aspects, wherein two of the at least two different non-Group I metal cations are selected from the group consisting of Ta and V cations, Ta and Cr cations, Ta and Mn cations, Ta and Fe cations, Ta and Co cations, Ta and Ni cations, Ta and Cu cations, and Ta and W cations.

Aspect 42. The cathode material according to any one of the foregoing aspects, wherein two of the at least two different non-Group I metal cations are selected from the group consisting of Ta and Cr cations, Ta and Mn cations, Ta and Fe cations, Ta and Cu cations, and Ta and W cations.

Aspect 43 The cathode material according to any one of the foregoing aspects, wherein two of the at least two different non-Group I metal cations are selected from the group consisting of Al and V cations, Al and Cr cations, Al and Mn cations, Al and Fe cations, Al and Co cations, Al and Ni cations, Al and Cu cations, and Al and W cations.

Aspect 44. The cathode material according to any one of the foregoing aspects wherein two of the at least two different non-Group I metal cations are selected from the group consisting of Al and Cr cations, Al and Mn cations, Al and Fe cations, Al and Cu cations, and Al and W cations.

Aspect 45. The cathode material according to any one of the foregoing aspects, wherein two of the at least two different non-Group I metal cations are selected from the group consisting of Sn and V cations, Sn and Cr cations, Sn and Mn cations, Sn and Fe cations, Sn and Co cations, Sn and Ni cations, Sn and Cu cations, and Sn and W cations.

Aspect 46. The cathode material according to any one of the foregoing aspects wherein two of the at least two different non-Group I metal cations are selected from the group consisting of Sn and Cr cations, Sn and Mn cations, Sn and Fe cations, Sn and Cu cations, and Sn and W cations.

Aspect 47. The cathode material according to any one of the foregoing aspects, wherein two of the at least two different non-Group I metal cations are selected from the group consisting of Si and V cations, Si and Cr cations, Si and Mn cations, Si and Fe cations, Si and Co cations, Si and Ni cations, Si and Cu cations, and Si and W cations.

Aspect 48. The cathode material according to any one of the foregoing aspects wherein two of the at least two different non-Group I metal cations are selected from the group consisting of Si and Cr cations, Si and Fe cations, Si and Cu cations, and Si and W cations.

Aspect 49. The cathode material according to any one of the foregoing aspects, wherein the at least one counterion is selected from the group consisting of F—, Cl—, and Br—.

Aspect 50. The cathode material according to any one of the foregoing aspects, wherein the at least one counterion is F—.

Aspect 51. The cathode material according to any one of the foregoing aspects, wherein the voltage window is from about 2.0 V to about 4.5 V vs Li/Li⁺.

Aspect 52. The cathode material according to any one of the foregoing aspects, wherein the voltage window is from about 2.0 V to about 4.4 V vs Li/Li⁺.

Aspect 53. The cathode material according to any one of the foregoing aspects, wherein the voltage window is from about 2.5 V to about 4.3 V vs Li/Li⁺.

Aspect 54. The cathode material according to any one of the foregoing aspects, wherein the voltage window is from about 2.5 V to about 4.2 V vs Li/Li⁺.

Aspect 55. The cathode material according to any one of the foregoing aspects, wherein the voltage window is from about 2.5 V to about 4.1 V vs Li/Li⁺.

Aspect 56. The cathode material according to any one of the foregoing aspects, wherein the voltage window is from about 2.5 V to about 4.0 V vs Li/Li⁺.

Aspect 57. The cathode material according to any one of the foregoing aspects, which has a specific capacity measured according to the Specific Capacity Test of from 50% to 90% of the original specific capacity after from 500 to 1000 cycles according to the Galvanostatic Cycling.

Aspect 58. The cathode material according to any one of the foregoing aspects, which has a specific capacity measured according to the Specific Capacity Test of from 50% to 80% of the original specific capacity after from 500 to 1000 cycles according to the Galvanostatic Cycling.

Aspect 59. The cathode material according to any one of the foregoing aspects, which has a specific capacity measured according to the Specific Capacity Test of from 50% to 75% of the original specific capacity after from 500 to 1000 cycles according to the Galvanostatic Cycling Test.

Aspect 60. The cathode material according to any to any one of the foregoing aspects, which has a specific capacity measured according to the Specific Capacity Test of from 55% to 75% of the original specific capacity after from 500 to 1000 cycles according to the Galvanostatic Cycling Test.

Aspect 61. The cathode material according to any one of the foregoing aspects, which has a specific capacity measured according to the Specific Capacity Test of from 60% to 75% of the original specific capacity after from 500 to 1000 cycles according to the Galvanostatic Cycling Test.

Aspect 62. The cathode material according to any one of the foregoing aspects, which has an original specific capacity of from about 150 to 300 mAh/g measured according to the Specific Capacity Test.

Aspect 63. The cathode material according to any one of the foregoing aspects, which has an original specific capacity of from about 200 to 300 mAh/g measured according to the Specific Capacity Test.

Aspect 64. The cathode material according to any one of the foregoing aspects, which has an original specific capacity measured according to the Specific Capacity Test of from about 250 to 300 mAh/g.

Aspect 65. The Group I metal cation excess cathode material of to any one of the foregoing aspects, wherein an average particle size of the cathode material is from 5 nm to 100 μm as determined by the scanning electron microscopy.

Aspect 66. The cathode material according to any one of the foregoing aspects, which is selected from the group consisting of:
(i) Li_{1.3}Mn_{0.4}Nb_{0.3}O₂,
(ii) Li₂Mn_{3/4}Cr_{1/4}O₂F,
(iii) Li_{2.1}Mn_{0.75}Cr_{0.25}O_{2.05}F,
(iv) Li_{2.2}Mn_{0.75}Cr_{0.25}O_{2.1}F,
(v) Li_{2.1}Mn_{0.667}Nb_{0.333}O_{2.05}F
(vi) Li_{2.1}Mn_{0.5}Ti_{0.5}O_{2.05}F,
(vii) Li_{2.1}Mn_{0.45}Ti_{0.45}Al_{0.1}O_{2.05}F,
(viii) Li_{2.1}Mn_{0.45}Ti_{0.45}Fe_{0.1}O_{2.05}F,
(ix) Li₂Mn_{2/3}V_{1/3}O₂F and
(x) Li_{1.75}Mn_{0.45}Ti_{0.45}Fe_{0.1}O₂F_{0.75}, and
(xi) Li_{1.25}Mn_{0.45}Ti_{0.45}Fe_{0.1}O₂F_{0.25}.

Aspect 67. An electrochemical device comprising a cathode stack comprising a cathodic current collector and the Group I metal cation excess cathode material according to any one of the foregoing aspects, that is formed over at least a portion of the cathodic current collector.

Aspect 68. The electrochemical device according to any one of the foregoing aspects, further comprising:
(ii) an anode stack comprising an anodic current collector and an anode material that is formed over at least a portion of the anodic current collector;
(iii) a separator material between the cathode stack and the anode stack; and
(iv) an electrolyte;
wherein the electrochemical device is a battery.

Aspect 69. The electrochemical device according to any one of the foregoing aspects, wherein the anode material is selected from the group consisting of Graphite, Si, Li metal, Na metal, K metal, Sn, Graphite/Si composite, Graphite/Sn composite, Graphite/Li composite, Graphite/Na composite, Graphite/K composite, and hard carbon.

Aspect 70. The electrochemical device according to any one of the foregoing aspects, wherein the separator material is selected from the group consisting of a nonwoven fiber, a cotton fiber, a nylon, a polyester, a glass, a polymer film, a polyethylene, a polypropylene, a poly (tetrafluoroethylene), a polyvinyl chloride, a ceramic, a rubber, and an asbestos.

Aspect 71. The electrochemical device according to any one of the foregoing aspects, wherein the electrolyte is selected from the group consisting of liquid and solid materials comprising lithium, sodium, and/or potassium ions.

Aspect 72. A method of making the Group I metal cation excess cathode material of any one of the foregoing aspects, the method comprising:
(i) combining a salt, an oxide, and/or a peroxide of a Group I metal, a salt, an oxide, and/or a peroxide of a first non-Group I metal, and a salt, an oxide, and/or a peroxide of a second non-Group I metal to prepare a precursor;
(ii) ball milling the precursor to form a powder;
(iii) combining the powder with a molar excess of a flux material to form a mixture;
(iv) heating the mixture to an elevated temperature relative to room temperature for a period of time sufficient to form a calcined powder comprising the cathode material.

Aspect 73. The method according to any one of the foregoing aspects, further comprising (v) separating the cathode material from the flux material in the calcined powder.

Aspect 74. The method according to any one of the foregoing aspects, wherein the separating step in step (v) comprises dispersing the calcined powder in deionized water followed by centrifugation to separate the cathode material from the calcined powder.

Aspect 75. The method according to any one of the foregoing aspects, wherein the ball milling step (ii) comprises a wet ball milling with a suitable solvent.

Aspect 76. The method according to any one of the foregoing aspects, wherein the ball milling step (ii) comprises dry ball milling.

Aspect 77. The method according to any one of the foregoing aspects, further comprising in step (i) adding about 10% of a stochiometric excess of the salt of the Group I metal cation.

Aspect 78. The method according to any one of the foregoing aspects, wherein the flux material is selected from the group consisting of LiCl, LiNO₃, LiOH, LIF, Li₂SO₄, Li₂CO₃, CH₃C(O)OLi, NaCl, NaNO₃, NaOH, Na₂SO₄, Na₂CO₃, CH₃C(O)ONa, NaF, KCl, KNO₃, KOH, K₂SO₄, K₂CO₃, CH₃C(O)OK and KF.

Aspect 79. The method according to any one of the foregoing aspects, wherein the elevated temperature is from about 300° C. to about 1200° C.

Aspect 80. The method according to any one of the foregoing aspects, wherein the heating step (iv) comprising hearing the mixture at a heating rate of about 0.5° C./min to about 10° C./min.

Aspect 81. The method according to any one of the foregoing aspects, wherein the period of time is about 0.5 hours to about 20 hours.

Aspect 82. The method according to any one of the foregoing aspects, wherein a molar ratio of the flux material to the metal cation salts is from about 1 to about 30.

Aspect 83. A cathode material made by a method according to any one of the foregoing Aspects.

Aspect 84. A method of making a cathode, the method comprising
(i) dispersing a cathode material according to any one of the foregoing aspects with a binder material in a suitable solvent to form a slurry;
(ii) casting the slurry onto a cathodic current collector; and
(iii) allowing the suitable solvent to evaporate to form the cathode.

Aspect 85. The method according to any one of the foregoing aspects, wherein the binder material is selected from the group consisting of PVDF, CMC, PAA, and Cyrene.

Aspect 86. The method according to any one of the foregoing aspects, wherein a weight ratio of the cathode material to the binder material is from about 70/15 to about

Aspect 87. The method according to any one of the foregoing aspects, wherein the cathodic current collector comprises aluminum, carbon coated aluminum, carbon membrane, and/or copper.

Aspect 88. The method according to any one of the foregoing aspects, wherein allowing the suitable solvent to evaporate in step (iii) comprises heating to an elevated temperature with respect to room temperature for a period of time.

Aspect 89. The use of the Group I metal cation excess cathode material according to any one of the foregoing aspects in an electrochemical cell.

Aspect 90. The use of the Group I metal cation excess cathode material according to any one of the foregoing aspects in a battery.

### Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Synthesis and Characterization of Li₂Mn_{3/4}Cr_{1/4}O₂F (LMCOF): To synthesize LMCOF, a stoichiometric amount MnO (Sigma Aldrich, 99%, 10.125 mmol), CrO₃ (Alfa Aesar, 99%, 3.375 mmol), LiF (Alfa Aesar, 98%, 13.5 mmol), and Li₂O (Aldrich, 97%, 8.4 mmol) were dispersed in Ar-filled ZrO₂ jars (50 mL). A 10% excess of Li₂O was added to compensate possible loss during synthesis. The total amount of precursors was about 1.8 g. For ball milling, ten 10 mm-diameter and twenty-five 5 mm-diameter ZrO₂ balls were used as the grinding media. The ZrO₂ jars were sealed using parafilm and then covered by duct tape to ensure good sealing and no air leakage during ball milling. All the procedures were carried out in an Ar-filled glove box. The ZrO₂ jars were transferred out of the glove box and ball-milled for 45 min with a rotation frequency of 38 Hz followed by a 10-min interval. The operation was repeated for 70 cycles to ensure the effective ball-milling time reached 52 h. For synthesizing LMNOF and LMMOF, the same procedures were used and Nb₂O₅ and MoO₃ were used instead of CrO₃. The synthesized products were stored in a glove box for further utilization and characterization.

Phase structure, morphology and composition characterization: X-Ray Diffraction (XRD) was performed on a PANalytical X-ray diffractometer with Cu source at a scan rate of 2°/min. Synchrotron XRD was performed at the beam line 11-3 of Stanford Synchrotron Radiation Lightsource (SSRL) with a wavelength of 0.976 Å. Electrode samples were sealed between two Kapton tapes. A LaB₆ sample was placed in the same location as the other samples and was used to calibrate the diffraction configuration. 2D MAR345 diffraction images were converted to 1D diffraction patterns based on calibration parameters obtained from the LaB₆ diffraction pattern. The morphology of powder and the electrode was evaluated with scanning electron microscopy (SEM) on a FEI Quanta 600 FEG) and scanning transmission electron microscopy (STEM) was obtained using a JEM-ARM200F equipped with an energy dispersive X-ray (EDX) detector. Inductively coupled plasma (ICP) optical spectroscopy was performed on a Spectro ARCOS SOP (side-on or radial view of the plasma interface) made by Spectro Analytical Instruments Inc. X-ray total scattering experiments were carried out at the X-ray powder diffraction (XPD) beamline (28-ID-2) at the National Synchrotron Light Source II (NSLS-II, Brookhaven National Laboratory, USA), with a photon wavelength of 0.185794 Å. The diffraction patterns collected from the two-dimensional detector were radially integrated using Fit2D. The pair distribution functions, G (r), were extracted using PDFgetX3. Neutron total scattering data were collected at the Nanoscale-Ordered Materials Diffractometer (NOMAD) beamline at the Spallation Neutron Source (SNS) at Oak Ridge National Laboratory [35]. For the current experiment, about 0.3 g powder sample was loaded into a 3 mm quartz capillary. Four 30 min scans were collected for each powder sample and then summed together to improve statistics. The detectors were calibrated using scattering from a diamond powder standard prior to the measurements. Neutron powder diffraction data were normalized against a vanadium rod, the background (empty quartz capillary) was subtracted, and the total scattering structure factor S(Q) data were transformed to pair distribution function data G(r) using the specific IDL codes developed for the NOMAD instrument with the Q range of 0.2 to 25 Å⁻¹.

Operando and ex situ hard XAS characterization: Operando hard XAS measurements at the Mn and Cr K-edge were carried out at beamline 20-BM-B in the Advanced Photon Source at Argonne National Laboratory. For preparing the battery, holes were punched on the coin cell parts with a diameter of 2 mm and on the spacer with a diameter of 5 mm. The detailed description for assembling battery can be found in the later electrochemical measurement section. The holes on the two sides of the battery were sealed by Kapton tapes. Two aluminum wires were welded to each side of the battery. The battery was fixed on a homemade holder, connected to the electrochemical workstation, and cycled at current density of 100 mA g⁻¹. All measurements were performed in transmission mode at room temperature using a Si(111) fixed-exit, double-crystal monochromator. The ex situ hard XAS was measured in the transmission mode at beamline 20-ID of the Advanced Photon Source at Argonne National Laboratory. The charged/discharged electrode films were sealed in Kapton tapes in an Ar-filled glove box. Energy calibration of each spectrum was made by aligning the first derivative maximum of reference Mn, Cr, Nb and Mo XANES spectra collected simultaneously from the metal foils in the reference channel. To determine the valence states of the transition metals at different states of charge, we selected the nearly linear portion of the rising edge for integration we selected and defined for the integrated average intensity as the K-edge [36,37]. Similar method was used to determine the K-edge position of the references of Mn and Cr and confirmed that the calculated K-edge values were in a linear relationship with the valence state. The compounds LaCrO₃[38], CrO₂ and CaCr_{0.5}Fe_{0.5}O₃ [40], where Cr cations are octahedrally coordinated, were used as Cr³⁺ and Cr⁵⁺ references, respectively, for quantifying the Cr valence state in the LMCOF. Similarly, MnO, Mn₂O₃ and MnO₂ were used as Mn²⁺, Mn³⁺, and Mn⁴⁺ references for Mn in the LMCOF. The calculated K-edges at different states of charge were then compared with the reference K-edges. The valence states were determined based on the K-edge position shift relative to the references, and the corresponding capacity obtained according to the calculated valence states using coulometry. Fortran-based HAMA code was used to do Morlet wavelet transforms (MWT) of k² weighted EXAFS spectra [41,42]. For appropriate resolution in R- and k-space, a wavelet parameter combination of k=3 and σ=2 was found to be well suited to discriminate atomic contributions in the Fourier transforms of Mn and Cr K-edge EXAFS spectra.

Resonant Inelastic X-ray Scattering (RIXS) and soft X-Ray Absorption Spectroscopy (XAS) characterization: RIXS measurements were carried out at beamline 10-1 at the SSRL using a transition edge sensor (TES) spectrometer, which is the leading detector technology for nuclear materials analysis, sub-mm and mm-wave astrophysics, and X-ray experiments. The TES spectrometer consisted of a 240-channel energy-dispersive detector array facing the sample-X-ray interaction point at 90 degrees with regards to the incoming X-ray beam. The distance between the interaction point and the TES detector array was about 5 cm. To achieve higher energy resolution of the TES than in a normal operation mode, only a subset of the detector array (64 pixels) was employed during the O K-edge RIXS measurements, and each O K-edge was scanned at least 10 times to get signals with good resolution. The energy measured by the TES was calibrated through separate measurements of a reference sample consisting of C, N. O, and various transition metal oxides with known emission energies. Sample exposure to the air was minimized using N₂-filled glove bags during the sample mounting, and the samples were measured under ultra-high vacuum (UHV) chamber. No sign of radiation damage was observed in the RIXS measurements based on no noticeable change in the measured spectral shape between consecutive scans.

Soft XAS measurements were performed on the 31-pole wiggler beamline 10-1 at SSRL using a ring current of 350 mA and a 1000 L mm⁻¹ spherical grating monochromator with 20 μm entrance and exit slits, providing ˜10¹¹ ph s⁻¹ at 0.2 eV resolution in a 1 mm² beam spot. The electrodes were harvested from a conventional coin cell and dried before measurements in the ultra-high vacuum environment. The samples were mounted on an aluminum sample holder with double-sided carbon tape in an Ar-filled glove box and transferred to the UHV chamber and measured at room temperature using FY mode. All spectra were normalized by current from freshly evaporated gold on a fine grid positioned upstream of the main chamber.

X-ray Fluorescence Mapping (XFM) characterization. XFM experiments were performed at the microprobe hard X-ray 2-ID-D beamline at the APS. The samples were raster-scanned by a sub-micrometer focused X-ray beam with 10 keV photon energy. The fluorescent X-rays were detected by a single element Si-drift Vortex detector. The schematic of the experimental setup can be found in reference [43]. The raw data is processed and quantified by MAPS. All images presented in this work covers a 100 μm×100 μm area with 0.5 μm×0.5 μm pixel size.

Electrochemical measurements. For preparing the cathode, 280 mg active material and 80 mg carbon black were ball-milled in Ar-filled ZrO₂ jars at 30 Hz for 3 h with ten 10 mm-diameter and twenty-five 5 mm-diameter ZrO₂ balls as the grinding media. Polytetrafluoroethylene (PTFE, 10%) was added in a mortar as the binder and the weight ratio of active material, carbon black and PTFE is 7:2:1. The mixture was ground for 30 min before being rolled into a thin film. The thin film was overturned for several times to make it more even and more elastic. The cathode was cut into disks of 6 mm in diameter, with an active mass loading of 3-4 mg/cm². All of the procedures were performed in an Ar-filled glove box.

To assemble a cell for battery testing, 1M LiPFe in 3:7 weight ratio of ethylene carbonate/ethyl methyl carbonate with 2 wt. % vinylene carbonate (EC/EMC=3:7, VC 2%) solution, glass microfiber (Whatman® GF/D) and Li metal foil were used as the electrolyte, separator and anode, respectively. Coin cells (CR2032) were assembled in an Ar-filled glove box and tested on a Wuhan Land battery testing system at 22° C. For GITT measurements, the cell was charged/discharged at a current density of 50 mA g⁻¹ for 60 min, followed by relaxation for 5 h to reach a quasi-equilibrium state. The process was repeated until a preselected charging/discharging cutoff voltage was reached. For preparing prelithiated anodes, oxygen-enriched lignin-derived carbon membrane (OLCM) electrodes were fabricated by electrospinning lignin-based resin solution, carbonization and oxidation. The fabricated OLCM samples were cut into disks (10 mm diameter) as the host to accommodate Li metal. The coin cells (CR2032) were assembled in an Ar-filled glove box using Li foils as counter/reference electrodes, glass microfiber (Whatman® GF/D) as separators, OLCM as working electrodes. The cells were cycled at 0-1.0 V vs Li/Li⁺ and 0.2 mA cm⁻² for 5 cycles for activation. Then a 4.71 mAh cm⁻² metallic Li was plated onto the electrode at a constant current of 1.0 mA cm⁻² The pre-lithiated anodes were retrieved by disassembling the coin cell in an Ar-filled glove box. The full cells were assembled using the LMCOF cathodes and the prelithiated anodes with the same procedure as assembling half cells. The specific capacity was calculated on the loading of the active material in the cathode.

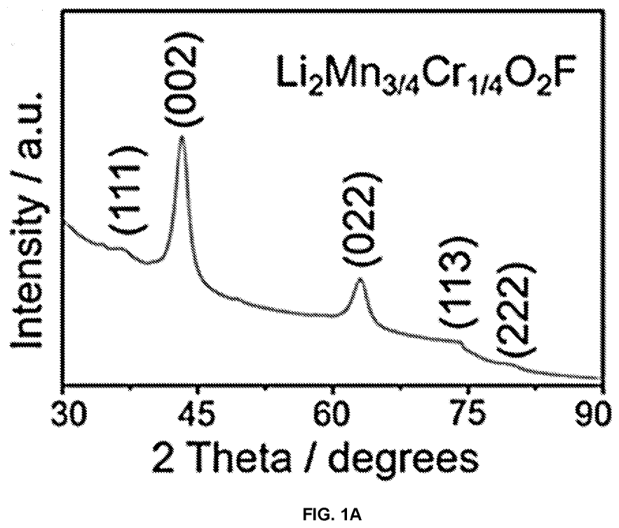

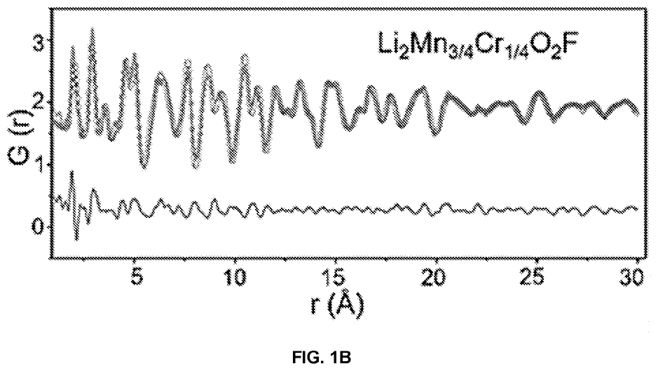

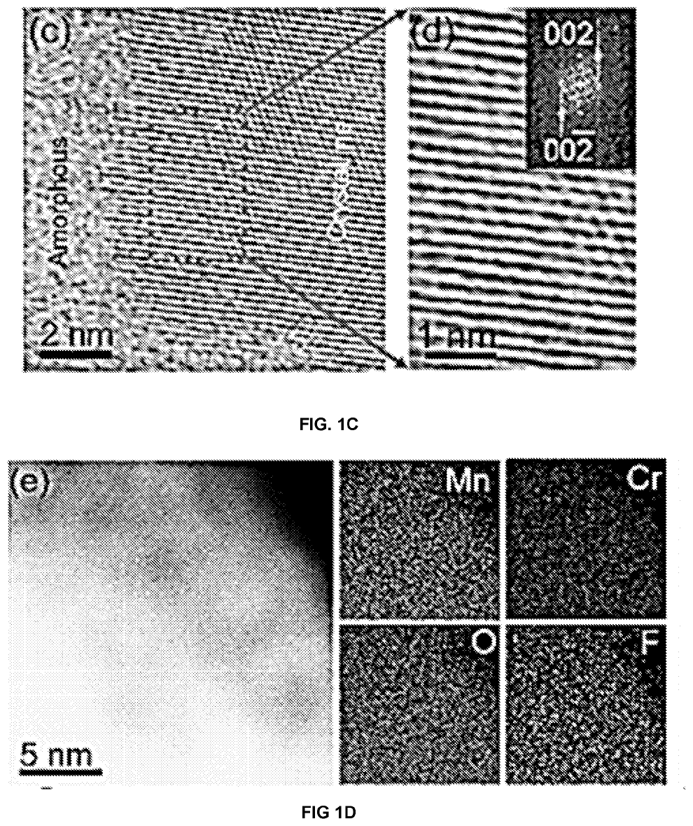

In addition to characterizing LMCOF, Li₂Mn_{2/3}Nb_{1/3}O₂F (LMNOF) and Li₂Mn_{3/4}Mo_{1/4}O₂F (LMMOF) were used as references to illustrate the distinct electrochemical properties of LMCOF. Synchrotron X-ray diffraction (XRD)(FIG. 1A) and neutron diffraction showed that all LMCOF, LMNOF, and LMMOF formed disordered rocksalt structures with an Fmm space group, in which O/F anions formed a cubic close-packed framework and Li/TM cations occupied the octahedral sites therein. Inductively coupled plasma mass spectrometry (ICP-MS) of LMCOF confirmed that the Li/TM stoichiometry was close to the designed Li₂Mn_{3/4}Cr_{1/4}O₂F empirical. X-ray and neutron pair distribution function (PDF) analyses, powerful techniques for providing insights into the nanoscale crystal structure, were used to investigate the atomic structure of the LMCOF in different length scales (FIG. 1B), and compared with the other two products. Generally, almost all the X-ray PDF peaks for the three products fitted well in the long r range of 10-30 Å, suggesting the consistency with the average cation disordered rocksalt structure. However, in the short r range (0.5-10 Å) especially for the two peaks standing at 1.6 and 3.1 Å, the average cation disordered model could adequately describe the observed structure features. The fit for LMCOF was noticeably better than the fits for LMMOF and LMNOF. The refined residual (R_{w}) value of LMCOF (25.77%) was smaller than those of LMNOF (35.97%) and LMMOF (39.44%), indicating that LMCOF likely possessed more disordered structure. This was further confirmed by the Rietveld refinement results of LMCOF and LMMOF using neutron PDF data. The more disordered structure in the LMCOF was ascribed to two factors: (i) the charge difference between Li⁺ and trivalent cations (Cr³⁺ and Mn³⁺) was smaller than that between Li⁺ and high valent cations of Nb⁵⁺ in LMNOF and Mo⁶⁺ in LMMOF, indicating a lower Coulombic force driving Cr³⁺/Mn³⁺ to minimize the electrostatic energy (Note: the presence of Cr³⁺/Mn³⁺ cations will be discussed in the next section); and (ii) Mn³⁺ (high spin d⁴) is a strong Jahn-Teller distortion cation, demonstrating LMCOF had stronger Jahn-Teller distortion of Mn³⁺-octahedra [44-46]. The combination of these two driving forces may have resulted in more disordered patterns in LMCOF. The highly disordered structure was reported to benefit the structural stability and immutability of Li⁺ local environment upon (de) lithiation [25]. These results indicated potential stability of LMCOF upon electrochemical cycling.

Scanning electron microscopy (SEM), transmission electron microscopy (TEM) and high-resolution TEM (HRTEM) images showed that the LMCOF polycrystalline particles were in the range of 100-200 nm, comprising 8-15 nm crystalline nanodomains. Moreover, a considerable amorphous structure was observed in the HRTEM image (FIG. 1C) indicating that LMCOF sample is composed of crystalline and amorphous nanodomains. The exposed facet and crystallographic characteristics of LMCOF were revealed by the HRTEM image and the corresponding fast Fourier transform (Inset in FIG. 1C). The energy dispersive spectroscopy (EDS) elemental mapping confirms that Mn, Cr, O, and F are co-present in the bulk phase, both in crystalline and amorphous areas (FIG. 1D). In summary, the microstructural characterization implied that the LMCOF contains a notable proportion of amorphous nanodomains and displays a low crystallinity and a high degree of disorder, which is different from many reported, high-crystalline DRX materials [12,14,17].

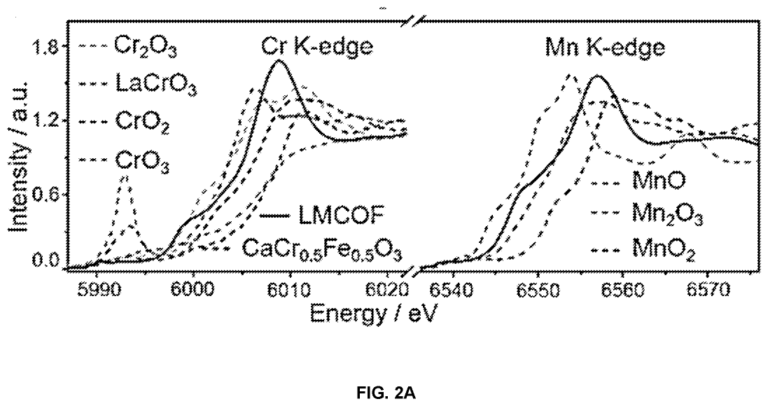

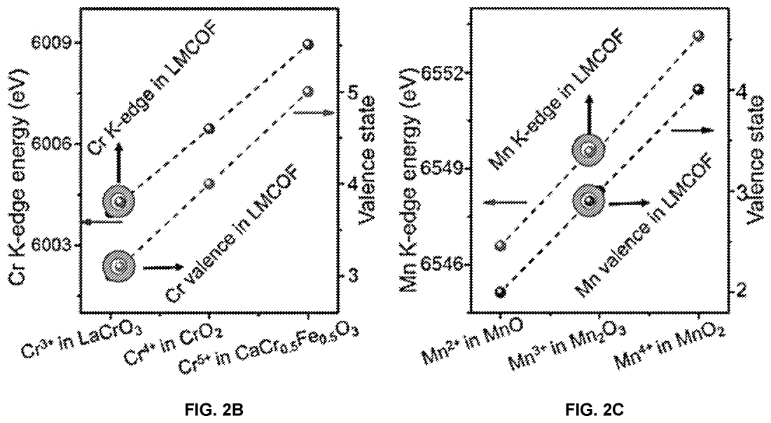

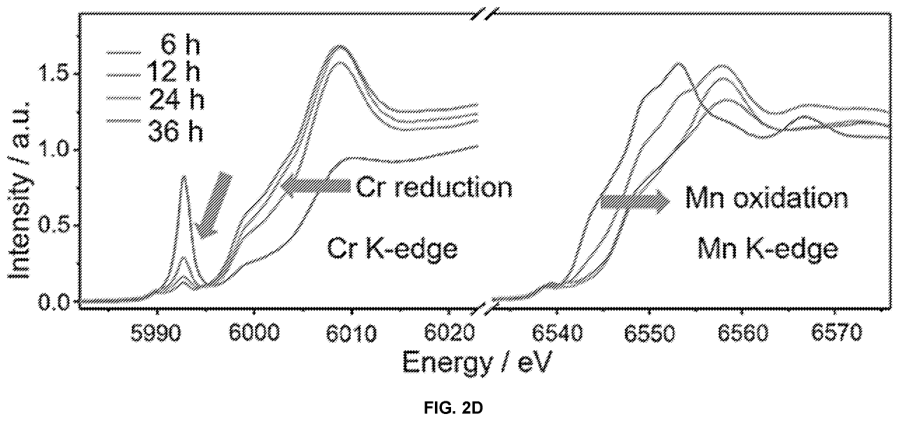

Hard X-ray absorption spectroscopy (hard XAS) was used to analyze the electronic structures of Cr and Mn in the LMCOF sample. The hard XAS spectra showed that LMCOF was mostly populated with cations close to Cr³⁺ and Mn³⁺ (FIG. 2A), indicating that Cr⁶⁺ is reduced and Mn²⁺ is oxidized during ball milling. Quantitative calculation of the valence states of Cr and Mn indicated the average valence states of TMs were Cr^{3.1+} and Mn^{2.9+} (FIG. 2B and FIG. 2C), the detailed calculation method is discussed in Experimental Methods). XAS and XRD at different stages of ball milling were used to systematically track the redox process between Cr and Mn during mechanosynthesis and characterize the chemical and phase transformations from precursors to LMCOF (FIG. 2D). The Cr pre-edge intensity gradually decreased, and the K-edge experienced a red shift with increasing reaction time, indicating the gradual reduction of Cr⁶⁺ to lower valence states. In contrast, Mn K-edge exhibited a gradual blue shift upon ball milling, demonstrating the oxidation of Mn²⁺ towards higher valence states. The transformation to disordered rocksalt LMCOF was completed after 48 hours of ball milling. Since both Cr and Mn were nearly in the trivalent state, it was apparent that Cr and Mn were both redox active and that LMCOF has the potential to become a promising cathode material. The theoretical redox capacity based on Cr³⁺/Cr⁶⁺ and Mn³⁺/Mn⁴⁺ redox couples was estimated to reach 329 mAh g⁻¹.

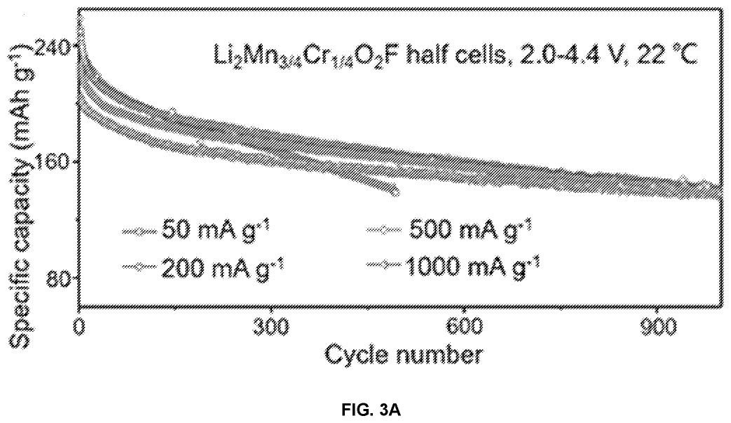

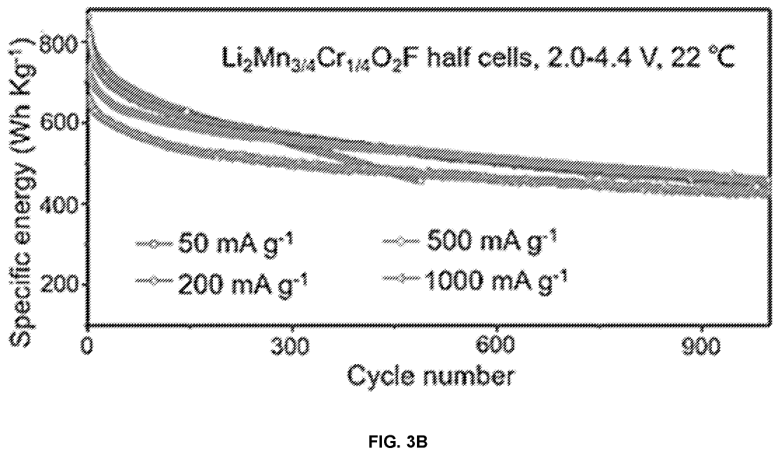

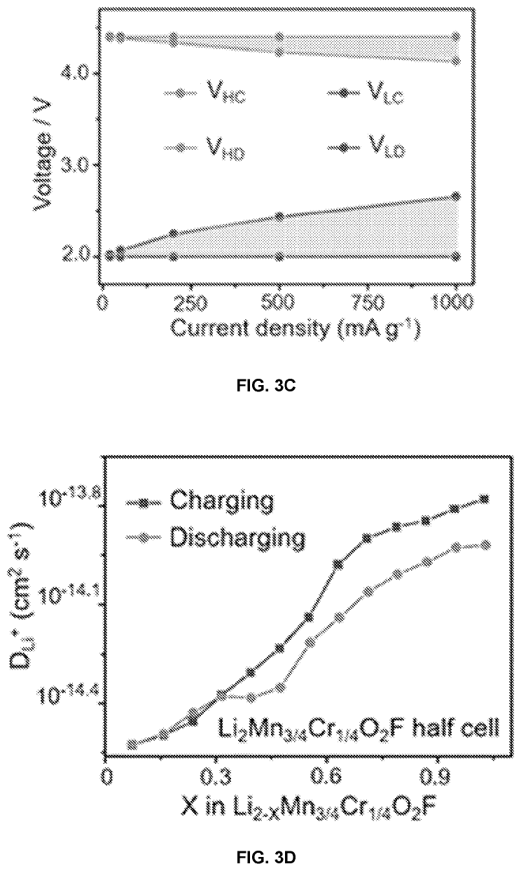

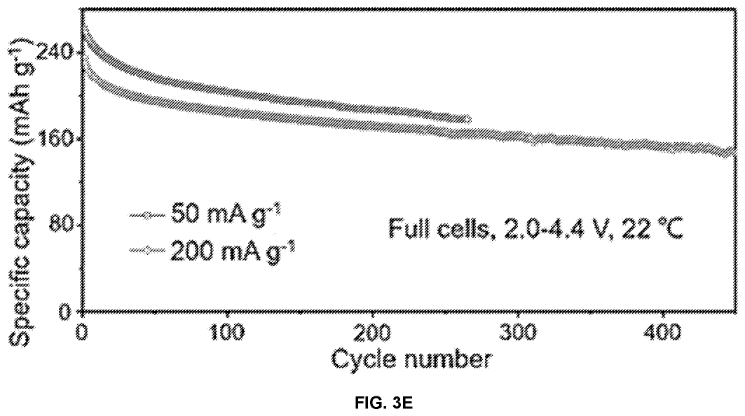

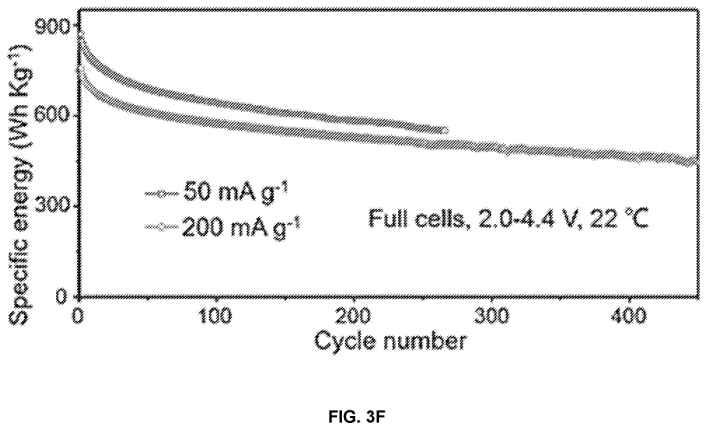

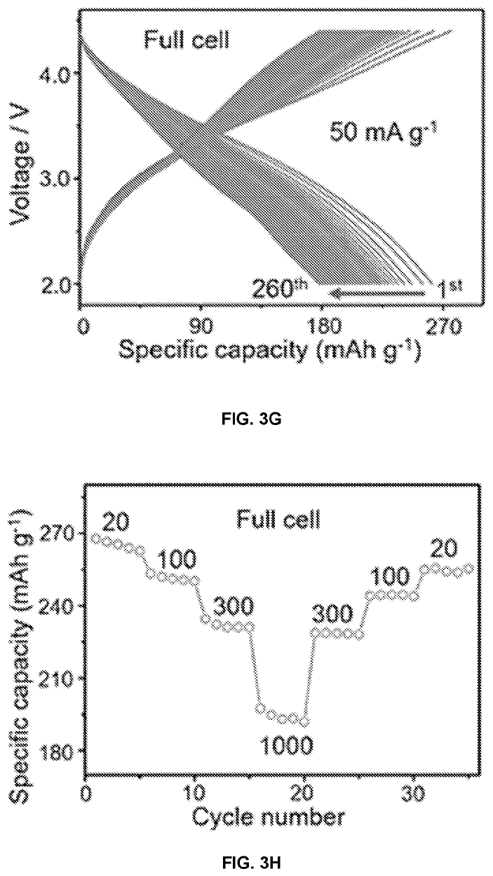

Developing DRX materials with high capacity and energy, long cycle life, and high rate capability represents a critical path towards promoting their applications. The LMCOF delivers a high specific discharge capacity of 258 mAh g⁻¹, specific energy of 832 Wh Kg 1, and a capacity retention of 57.6% after 500 cycles at 2.0-4.4 V and 50 mA g⁻¹ (FIG. 3A and FIG. 3B). Increasing the current density to 200, 500 and 1000 mA g: 1, the batteries deliver small decrease of specific capacity and energy, and all the retention performance are well over 60% after 1000 cycles (FIG. 3A and FIG. 3B). It is worth noting that the capacity fading mainly occurs in the first 50 cycles, and the retention performance is much better beyond 50 cycles, with only 0.03% capacity fading averagely per cycle. The Coulombic and energy efficiency delivered by the LMCOF are also quite stable at different current densities. We have highlighted the advantages of our materials by directly comparing LMCOF with other reported cathodes. The Cr³⁺ in LMCOF is expected to play a critical role for enhancing the specific capacity, specific energy, and cycling durability. The results demonstrate that the cycle life of LMCOF is promising as a DRX material. FIG. 3C shows the voltage drop and jump of the LMCOF half cells at the beginning/end of charge/discharge at different current densities. Particularly, the voltage drop of V_{HC}-V_{HD} remains relatively small when increasing the current density from 20 to 1000 mA g⁻¹. The small voltage drop at the upper voltage cutoff (FIG. 3C) reveals the fairly good stability and rate capability of LMCOF at high current densities [1]. The galvanostatic intermittent titration technique (GITT) result (FIG. 3D) shows that the Li⁺ diffusion coefficient in LMCOF reaches 10⁻¹⁴, 10⁻¹³ cm²/s, which is higher than other DRX materials [18] and some layered oxides [47,48], such as Li_{1.2}Ni_{0.15}Co_{0.1}Mn_{0.55}O₂ (10⁻¹⁷-10⁻¹⁴ cm²/s) [47] and Li [Li_{0.23}Co_{0.3}Mn_{0.47}] O₂ (10⁻¹⁸-10⁻¹⁴ cm²/s) [48].

Next we assembled full cells using prelithiated, oxygen-enriched lignin-derived carbon membranes (OLCM@Li) as anodes (see Experimental Methods) [49]. When cycled at 50 and 200 mA g⁻¹, the OLCM@Li∥LMCOF full cells deliver specific discharge capacity of 257 and 233 mAh g⁻¹ (FIG. 3E and FIG. 3G), specific energy of 859 and 776 Wh kg⁻¹ (FIG. 3F), capacity retention of 67.5% after 270 cycles and 57.9% after 450 cycles (FIG. 3E), respectively. The OLCM@Li∥LMCOF full cells also exhibit reasonably good rate capability (FIG. 3H) and Coulombic efficiency. The performance of OLCM@Li∥LMCOF full cells is comparable with the half cells containing bulk Li metal as the anodes (FIG. 3A and FIG. 3B).

Furthermore, we compare the battery performance of LMCOF with that of other DRX materials, such as LMNOF and LMMOF, under the identical electrochemical conditions. LMCOF exhibits considerably better specific capacity, energy and cycle life than LMMOF and LMNOF. We also compared the battery performance of LMCOF with other DRXs that contains Mn³⁺ or Cr³⁺ species. LMCOF displays comparable or even better specific capacity and cycle life than most of these DRXs. The highly disordering structure in DRX materials is found to positively impact the battery performance [14,25]. We also confirm that the LMCOF possess a higher degree of disordered structure than LMNOF and LMMOF. Another difference between LMCOF and other DRX materials is that the valence states of TM species in LMCOF are nearly trivalent (Cr^{3.1+} and Mn^{2.9+}), and there may be Mn/Cr dual redox during cycling. However, the Nb⁵⁺ and Mo⁶⁺ charge compensators in LMNOF and LMMOF are electrochemically inactive during cycling, as confirmed by hard XAS shown. Therefore, the higher degree of disordering structure and Mn/Cr dual redox (more discussion later) may have enabled the superior performance of LMCOF.

Based on the above results, it was apparent that high retention performance of LMCOF was attributable to the fact that the Mn/Cr dual redox species contributed more redox capacity at low voltages, thus eliminating the need of oxygen redox that typically occurs at high voltages [17,28,50].

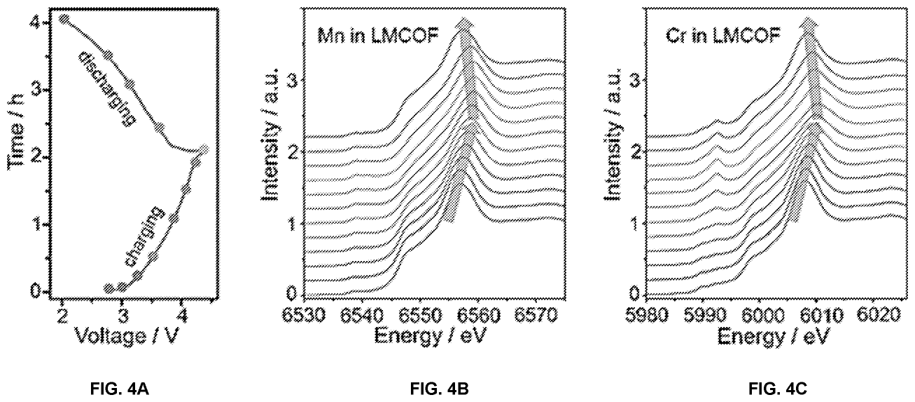

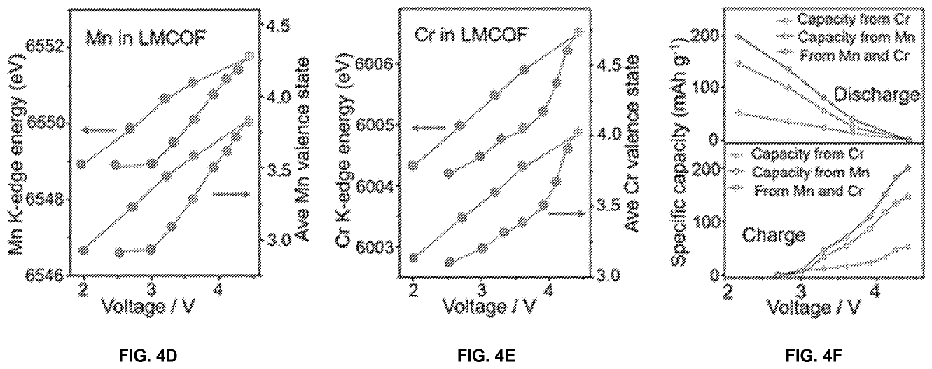

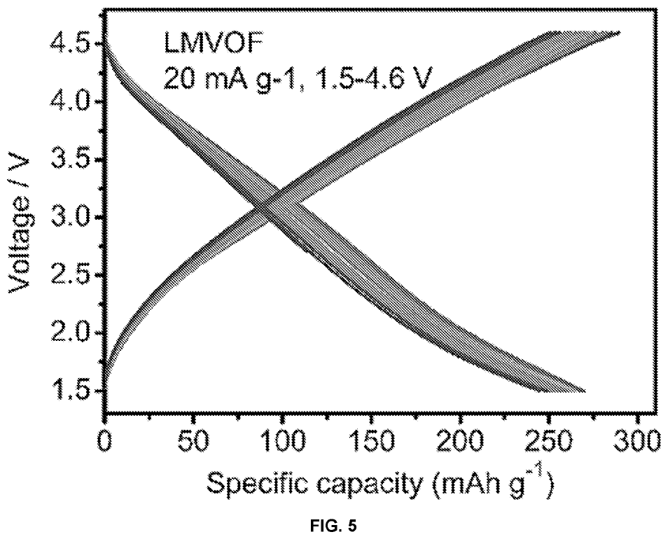

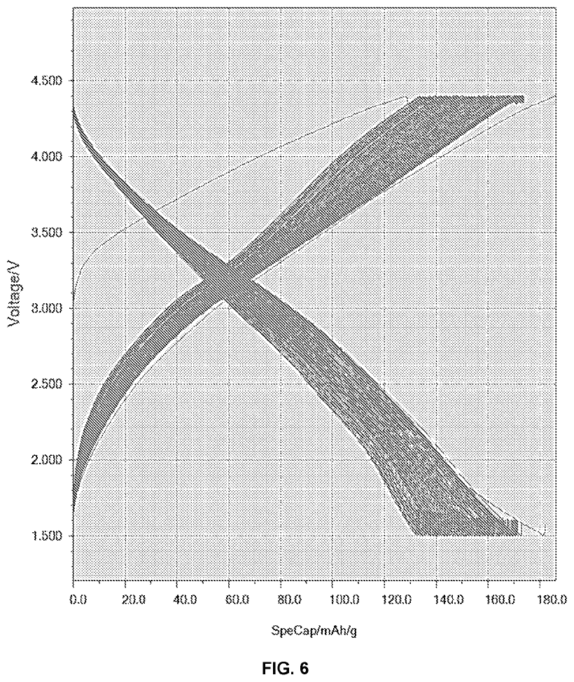

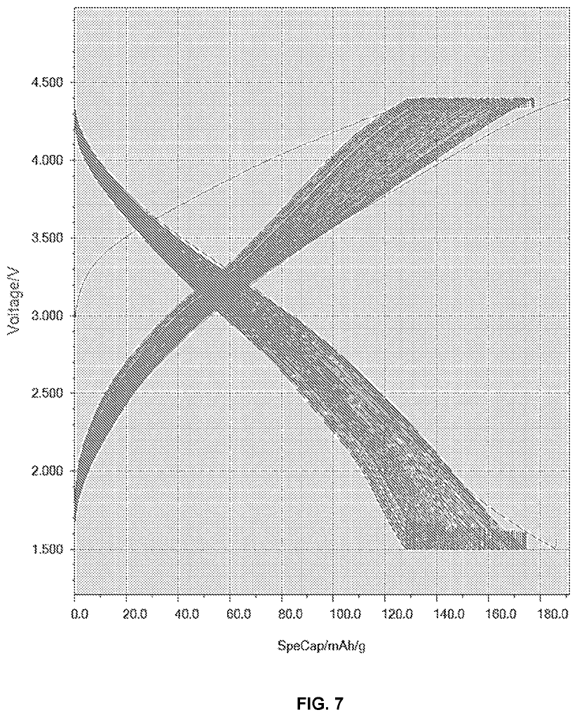

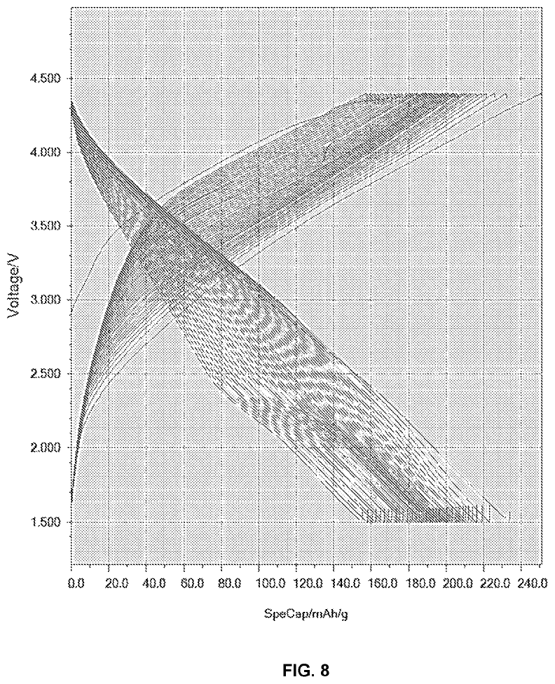

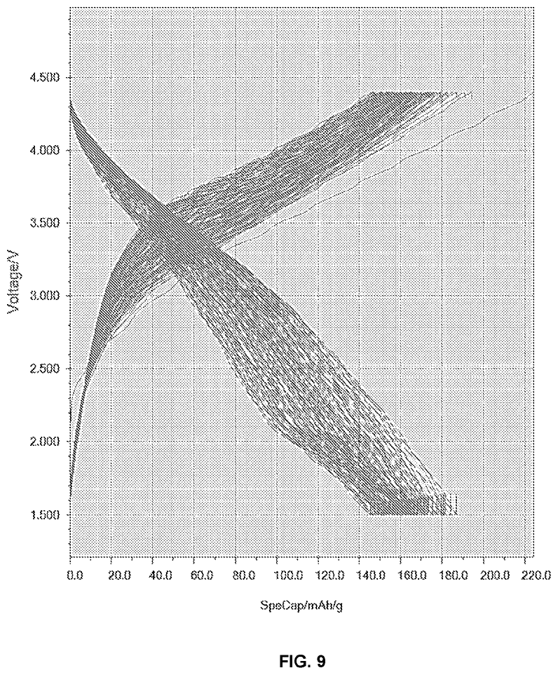

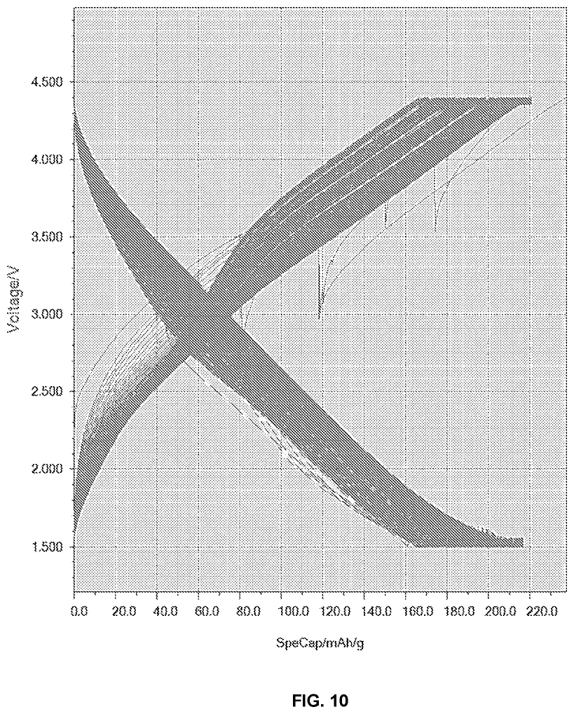

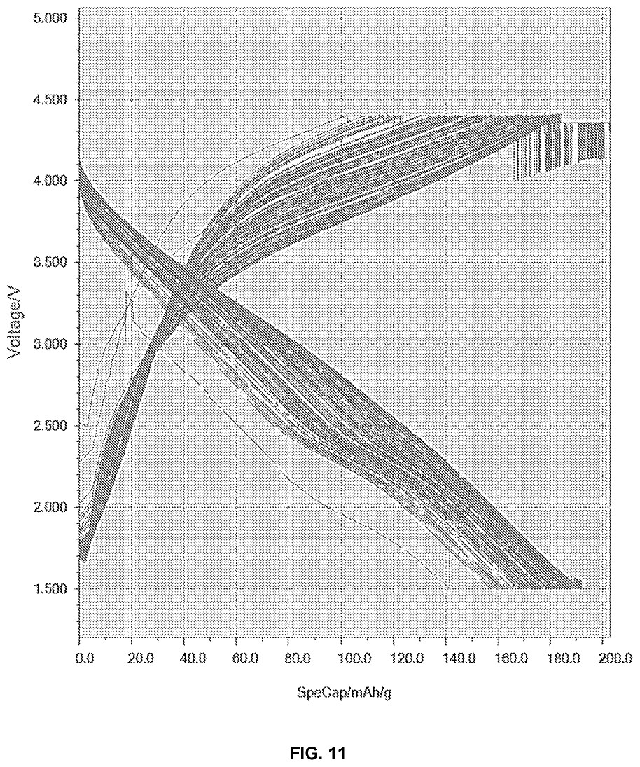

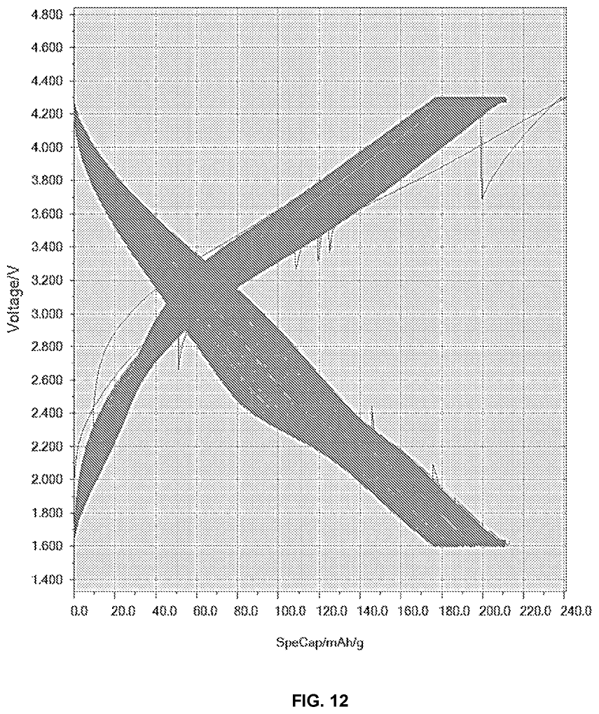

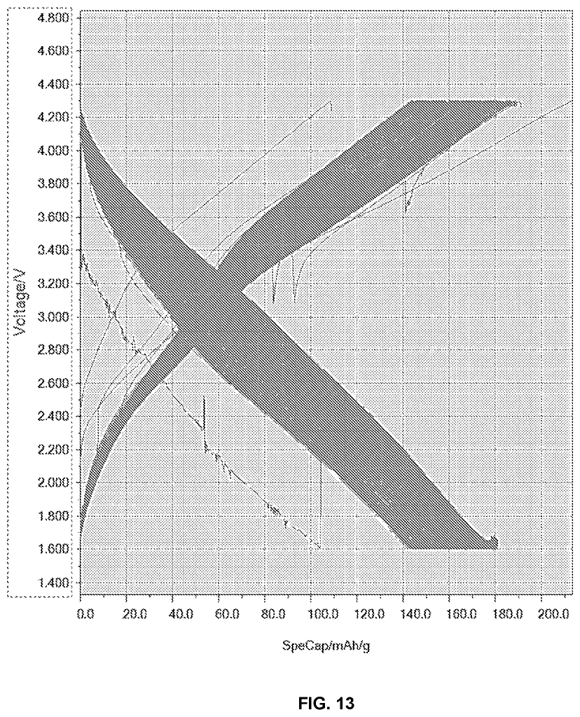

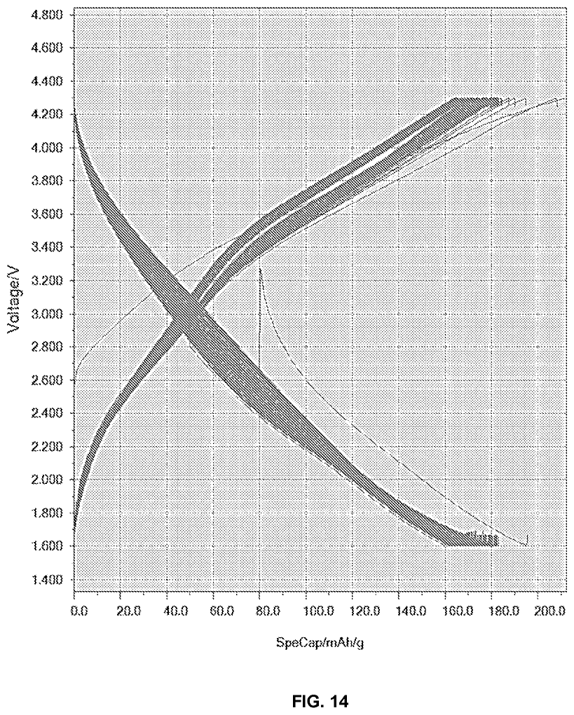

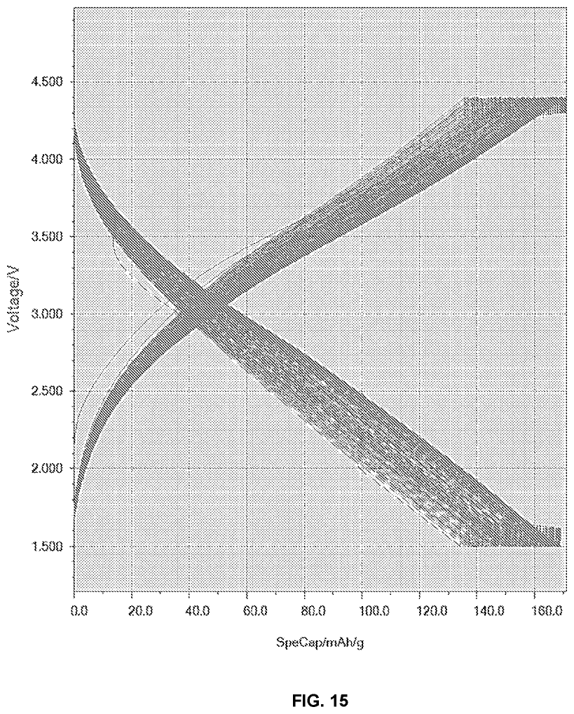

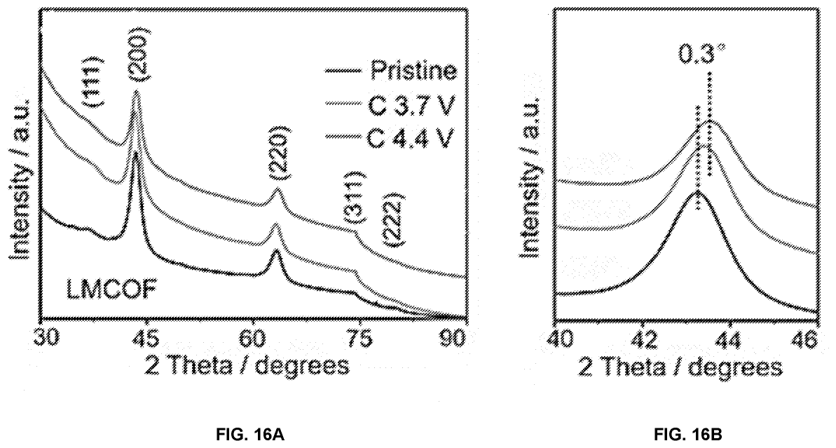

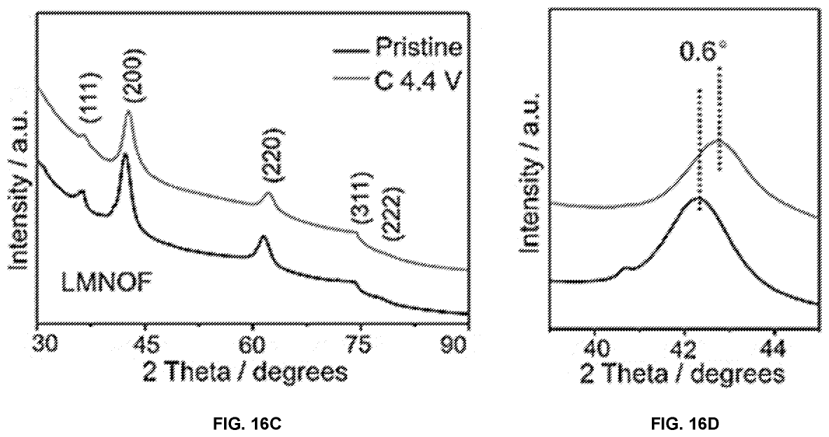

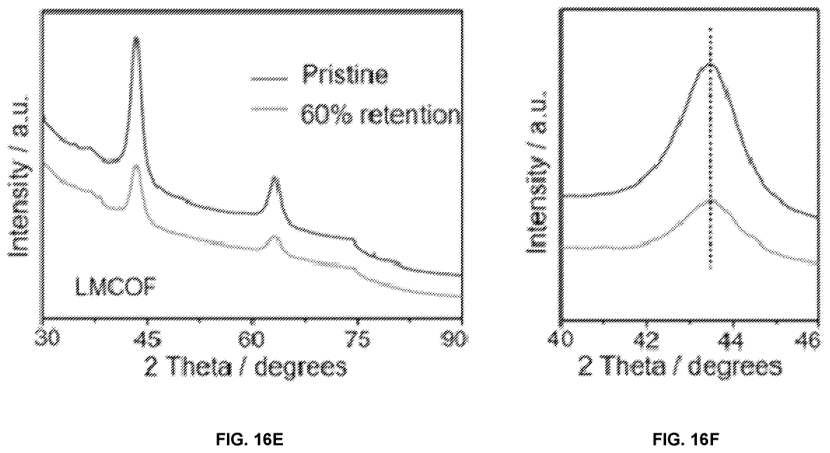

Chemical and Structural Evolution of Li₂Mn_{3/4}Cr_{1/4}O₂F during Cycling. Operando hard XAS was used to investigate a charge compensation mechanism of LMCOF upon battery cycling. Corresponding to the sampling points shown in FIG. 4A, both Mn and Cr K-edge XAS spectra exhibited blue shift during charging, and then returned to the initial position after discharging (FIG. 4A and FIG. 4B), indicating Mn and Cr were dual redox active species and their redox reactions took place synchronously throughout the cycle. Furthermore, the Mn and Cr valence states were calculated at each state of charge (FIG. 4D and FIG. 4E). Based on the coulometry, the capacity contributed by Mn and Cr during cycling (FIG. 4F) calculated. The calculated discharge capacity contributed by the Mn/Cr dual redox was ˜198 mAh g⁻¹, indicating about 21.7% capacity (˜55 mAh g⁻¹) was contributed by the oxygen redox. This result was also confirmed by the ex situ hard XAS of the LMCOF, where the discharge capacity from oxygen redox was ˜22.8%. For comparison, we also calculated the TM and oxygen redox capacity of LMNOF and LMMOF were examined using the same method based on their respective hard XAS spectra and is oxygen redox contributed 42.4% (84 mAh g⁻¹) and 59.4% (101 mAh g⁻¹) to the capacity of LMNOF and LMMOF, respectively. The percentage of oxygen redox capacity in LMNOF and LMMOF is much larger than that in LMCOF. This phenomenon is consistent with cyclic voltammetry (CV) results. Cyclic voltammetry (CV) is a commonly used method to investigate the degree of oxygen redox involvement [17,28]. The rising feature around 4.4-4.7 V is often attributed to the environmental change or the oxidation of O²⁻, and the continuous decrease in the intensity suggested the irreversibility of the oxygen redox [17,28]. Comparing the CV profiles of LMCOF with those of LMNOF and LMMOF, the oxygen redox feature (˜4.4 V) for appears repeatedly. and weaker than those of LMNOF and LMMOF. This suggests that only a trace amount of oxygen redox contributed to the capacity in the LMCOF and its contribution was reversible. Therefore, less oxygen redox was triggered in the LMCOF during cycling at 2.0-4.4 V, an unexpected result of the experiments.

Morlet wavelet transform (MWT) analyses for Mn and Cr based on the k²-weighted extended X-ray absorption fine structure (EXAFS) at different states of charge and discharge were done. This provided a means to identify overlapping contributions in EXAFS signals from neighboring atoms with multiple-scattering [42,51,52].

It is hypothesized that oxygen redox, especially oxygen release, as well as the structural and chemical degradation are together responsible for the battery performance deterioration [28]. In order to investigate that, synchrotron XRD was done to investigate the structural evolution of LMCOF at different states of charge and discharge as well as after long-term cycles. It was unexpectedly found that LMCOF was distinct from reported DRX materials where secondary phases were found to form in a short period of cycling (tens of cycles) [17,28]. It is also noted that such a good cycle life (60% capacity retention after 1,000 cycles) may be adequate for certain practical applications.

Considering the close relationship between oxygen chemical environment and battery stability for long-term cycling [9.13, 17.25,27-31], we investigated how an oxygen chemical environment evolved during cycling using synchrotron X-ray core-level spectroscopy. Resonant inelastic X-ray scattering (RIXS), with a probing depth of over 150 nm (i.e., bulk sensitive for the nanosized LMCOF particles) [53], has been shown effective in resolving the oxygen chemical environment, including oxygen redox activity. (RIXS works by probing specific X-ray emission energy at a particular excitation energy [48,53].) Using this technique, we identified a reversible oxygen chemical environment in the LMCOF. For pristine LMCOF the O K-edge RIXS map was composed of two features centered at about 530.5 and 534 eV, respectively [54]. Compared with the pristine sample, the RIXS maps of the half and fully charged LMCOF exhibited an increasing intensity at 530.5 eV and a decreasing intensity at 534 eV indicating the increasing TM-O covalency upon charging. This is a typical phenomenon observed in cathode materials with TMs as the main redox active sites [53-57].

However, we did not observe peroxo-like species in the RIXS map of fully charged LMCOF [48,53], demonstrating oxygen O²⁻ ions were only weakly oxidized and could not be oxidized to a higher valence state, such as O₂²⁻ or other O₂ species. In other words, it is plausible that under the conditions unexpectedly found here, oxygen redox was weak and its RIXS signal contribution was overrun by the TM-O covalency signal. After one complete cycle the critical features of the RIXS map were restored, verifying the reversibility of the oxygen chemical environment. The evolution of the oxygen chemical environment in the RIXS maps was consistent with the super-partial fluorescence yield (SPFY) signal. To track the oxygen stability in the LMCOF upon cycling, soft XAS in the fluorescence yield (FY) mode (probing ˜50 nm) was performed on the LMCOF after 50 cycles. Interestingly, no noticeable changes were observed for the O K-edge spectra upon charging and discharging, indicating that no oxygen redox participated in the reaction and that only Mn and Cr redox contributed to the capacity after 50 cycles. It is also likely that the surface underwent gradual degradation and becomes passivated after 50 cycles, a phenomenon that is widely reported for various oxide cathode materials [25,53-60]. Collectively, the RXIS and soft XAS results may explain the oxygen reversibility in the LMCOF and the faster capacity fading in the first 50 cycles than the subsequent cycles.

Finally, we investigated the capacity fading mechanism at the first 100 cycles for the LMCOF-based Li-ion batteries. We conjectured that this phenomenon might be related to the TM dissolution. The hard XAS results demonstrated that the Cr K-edge position keep stable even after 100 cycles. However, the Mn K-edge spectra display positive shift upon extending cycling, suggesting the valence state of Mn increased in LMCOF. Then, we performed X-ray fluorescence microscopy (XFM) to analyse the Cr and Mn deposition on the lithium anode which is highly sensitive to quantitatively evaluate TMs at the sub-ppm level. The range of the Mn concentration on the anode was 0.5-7.0 μg/cm², and the mean value was 3.7 μg/cm² (67.3 nmol/cm²) after 100 cycles. However, only trace amounts of Cr were detected after 100 cycles. Therefore, to keep electroneutrality, it was required that the Mn in the lattice of LMCOF would be oxidized when part of Mn was dissolved in the electrolyte after cycling. To confirm, we excluded the potential effect of the anode side by reassembling the LMCOF (after 20 cycles) with new anodes. The results showed that the reassembled battery could essentially continue the capacity and stability trend compared with the original ones, suggesting the anode had no major influence on the capacity degradation of LMCOF in the initial cycles. In addition, the TEM, HRTEM, and XRD were performed on the LMCOF that finished 50 cycles The diffraction peaks became weakly broader, demonstrating the slightly decreased crystallinity of LMCOF after initial cycling. These results confirmed the main cubic structure was stable during long-term cycling.

### Tests and Protocols

Redox Potential Measurement Method: The Redox Potential Measurement Method involves determining the redox potential using a combination of X-ray absorption spectroscopy measured during galvanostatic cycling of a Test Cell. A Test Cell containing the cathode material is charged for 2 hours and discharged for 2 hours at a rate of from about 10 mA/g. Voltage measurements are made at recorded times after the test begins. Hard X-ray absorption spectra (XAS) are taken at each recorded time. The hard XAS is measured in the transmission mode at beamline 20-ID and 20-BM of the Advanced Photon Source at Argonne National Laboratory. Energy calibration of each spectrum is made by aligning the first derivative maximum of a reference non-Group I X-ray absorption near edge structure (XANES) spectra collected simultaneously from the metal foils in the reference channel. To determine the valence states of the non-Group I metals at different positive charges, a linear portion of the rising edge for integration is defined as the integrated average intensity as the K-edge according to the published method of Farges et al., Phys Rev. B Condens. Matter Mater. Phys. 56 (4)(1997) 1809-1819; and H. Modrow et al., Phys Rev. B Condens. Matter Mater. Phys. 67 (3)(2003) 035123. The calculated K-edges at different states of charge are compared to reference K-edges. Valence states can be determined based on the K-edge position shift relative to the references. Fortran-based HAMA code is used to do Morlet wavelet transforms (MWT) of k2 weighted extended X-ray absorption fine structure (EXAFS) spectra according to Xia et al., Phys Rev. B Condens. Matter 542 (2018) 12-19 and Mikutta et al., Environ. Sci. Technol. 45 (12)(2011) 9550-9557.

Specific Capacity Test: The Specific Capacity Test is used to measure the amount of electric charge (typically in milliampere hours or mAh) the cathode material can deliver per unit mass (typically grams) of material (mAh/g). The test is performed on a Test Cell at about room temperature (e.g., about 22° C.) under Galvanostatic Cycling. Specific capacities can be reported herein as after a number of cycles (n), which means the amount of charge on the nth cycle. A specific discharge capacity of the cathode material in the first Galvanostatic Cycle is defined as the original specific capacity under the above-stated conditions.

Galvanostatic Cycling: Test Cells can be cycled using Galvanostatic Cycling on the Test Cell which includes the test cathode material at about room temperature (e.g., about 22° C.) is effected at a rate of 50 mA/g, and at a voltage range of from about, 2.0 to 4.5V. The reference electrode is lithium metal. In each Test Cell, the charging process is started from the open circuit voltage and a positive current at the set rate is applied to the cell. Meanwhile the voltage of the Test Cell is monitored. When the voltage reaches the upper cutoff, the charging process is completed. Then, a negative current at the set rate is applied to the cell. Meanwhile the voltage of the Test Cell is monitored. When the voltage reaches the lower cutoff, the discharging process is completed. Repeating such a charging-discharging cycle increases the number of cycles.

Specific Capacity Deconvolution Procedure: The Specific Capacity Deconvolution Procedure is used to assign percentages of the specific capacity to individual atomic centers in the cathode material. The measurement is performed by determining the valence states of the non-Group I metals at different states of charge as in the Redox Potential Measurement Method. A linear portion of the rising edge for integration is defined as the integrated average intensity as the K-edge according to the published method of Farges et al., Phys Rev. B Condens. Matter Mater. Phys. 56 (4) (1997) 1809-1819; and H. Modrow et al., Phys Rev. B Condens. Matter Mater. Phys. 67 (3)(2003) 035123. The calculated K-edges at different states of charge are compared to reference K-edges. Valence states can be determined based on the K-edge position shift relative to the references. The change of the valence state can be calculated by subtracting the original valence state from the valence state. The capacity contribution from the non-Group I metal is then calculated using the coulometry. The same process is repeated for different non-Group I metals in the material. To calculate the contribution from the oxygen redox, the total capacity is subtracted by the total capacity from the non-Group I metals.

Test Cell: Many of the measurements performed involve measurements performed on a Test Cell containing the cathode material. To prepare a Test Cell, a poly (vinylidene difluoride)(PVDF) binder is dissolved in N-methyl-2-pyrrolidone, followed by addition of the cathode material and acetylene carbon with mixing to form a slurry. A weight ratio of cathode material: PVDF: acetylene carbon is 8:1:1. The slurry is then casted onto an Al foil and dried overnight at 120° C. in a vacuum to form a dry composite electrode. The dry composite electrode is punched into disks with a diameter of about 10 mm and a cathode material mass loading of about 3.5 mg cm⁻². The Test Cells are assembled in CR2032-type coin cells with the composite electrode as the cathode and the Group I metal as the anode. The separator is Whatman glass fiber (1827-047934-AH) and the electrolyte is 1M of a Group I metal salt in a cyclic carbonate solvent. For example, lithium hexafluorophosate may be dissolved in a 1:1 by-volume mixture of ethylene carbonate (EC): diethylene carbonate (DEC).

### REFERENCES

[1] X. Li, Y. Qiao, S. Guo, K. Jiang, M. Ishida, H. Zhou, A new type of Li-rich rock-salt oxide Li₂Ni_{1/3}Ru_{2/3}O₃ with reversible anionic redox chemistry, Adv. Mater. 31(11)(2019)1807825.
[2] R. J. Clément, D. Kitchaev, J. Lee, Gerbrand Ceder, Short-range order and unusual modes of nickel redox in a fluorine-substituted disordered rocksalt oxide lithium-ion cathode, Chem. Mater. 30 (19)(2018) 6945-6956.
[3] S. Hoshino, A. M. Glushenkov, S. Ichikawa, T. Ozaki, T. Inamasu, N. Yabuuchi, Reversible three-electron redox reaction of Mo³⁺/Mo⁶⁺ for rechargeable lithium batteries, ACS Energy Lett. 2(4)(2017)733-738.
[4] R. Wang, X. Li, L. Liu, J. Lee, D. H. Seo, S. H. Bo, A. Urban, G. Ceder, A disordered rock-salt Li-excess cathode material with high capacity and substantial oxygen redox activity: Li_{1.25}Nb_{0.25}Mn_{0.5}O₂, Electrochem. Commun. 60 (2015) 70-73.
[5] N. Yabuuchi, M. Takeuchi, S. Komaba, S. Ichikawa, T. Ozaki, T. Inamasu, Synthesis and electrochemical properties of Li_{1.3}Nb_{0.3}V_{0.4}O₂ as a positive electrode material for rechargeable lithium batteries, Chem. Commun. 52 (10)(2016) 2051-2054.
[6] D. A. Kitchaev, Z. Lun, W. D. Richards, H. Ji, R. J. Clément, M. Balasubramanian, D. H. Kwon, K. Dai, J. K. Papp, T. Lei, B. D. McCloskey, W. Yang, J. Lee, G. Ceder, Design principles for high transition metal capacity in disordered rocksalt Li-ion cathodes, Energy Environ. Sci. 11 (8)(2018) 2159-2171.
[7] N. Pereira, F. Badway, M. Wartelsky, S. Gunn, G. G. Amatucci, Iron oxyfluorides as high capacity cathode materials for lithium batteries, J. Electrochem. Soc. 156 (6)(2009) A407-A416.
[8] N. Takeda, S. Hoshino, L. Xie, S. Chen, I. Ikeuchi, R. Natsui, K. Nakura, N. Yabuuchi, Reversible Li storage for nanosize cation/anion-disordered rocksalt-type oxyfluorides: LiMoO2-xLIF (0≤x≤2) binary system, J. Power Sources 367 (2017) 122-129.
[9] L. Zhang, D. Dambournet, A. ladecola, D. Batuk, O. J. Borkiewicz, K. M. Wiaderek, E. Salager, M. Shao, G. Chen, J. M. Tarascon, Origin of the high capacity manganese-based oxyfluoride electrodes for rechargeable batteries, Chem. Mater. 30 (15)(2018) 5362-5372.
[10] R. A. House, L. Jin, U. Maitra, K. Tsuruta, J. W. Somerville, D. P. Förstermann, F. Massel, L. Duda, M. R. Roberts, P. G. Bruce, Lithium manganese oxyfluoride as a new cathode material exhibiting oxygen redox, Energy Environ. Sci. 11 (4)(2018) 926-932.
[11] S. W. Kim, N. Pereira, N. A. Chernova, F. Omenya, P. Gao, M. S. Whittingham, G. G. Amatucci, D. Su, F. Wang, Structure stabilization by mixed anions in oxyfluoride cathodes for high-energy lithium batteries, ACS Nano 9 (10)(2015) 10076-10084.
[12] J. Lee, A. Urban, X. Li, D. Su, G. Hautier, G. Ceder, Unlocking the potential of cation-disordered oxides for rechargeable lithium batteries, Science 343 (6170) (2014) 519-522.
[13] J. Lee, D. A. Kitchaev, D. H. Kwon, C. W. Lee, J. K. Papp, Y. S. Liu, Z. Lun, R. J. Clément, T. Shi, B. D. McCloskey, J. Guo, M. Balasubramanian, G. Ceder, Reversible Mn²⁺/Mn⁴⁺ double redox in lithium-excess cathode materials, Nature 556 (7700)(2018) 185-190.
[14] H. Ji, A. Urban, D. A. Kitchaev, D. H. Kwon, N. Artrith, C. Ophus, W. Huang, Z. Cai, T. Shi, J. C. Kim, H. Kim, G. Ceder, Hidden structural and chemical order controls lithium transport in cation-disordered oxides for rechargeable batteries, Nat. Commun. 10 (1)(2019) 592.
[15] C. S. Johnson, J. S. Kim, C. Lefief, N. Li, J. T. Vaughey, M. M. Thackeray, The significance of the Li₂MnO₃ component in “composite” xLi₂MnO₃·(1-x)LiMn_{0.5}Ni_{0.5}O₂ electrodes, Electrochem. Commun. 6 (10)(2004) 1085-1091.
[16] R. Chen, R. Witte, R. Heinzmann, S. Ren, S. Mangold, H. Hahn, R. Hempelmann, H. Ehrenberg, S. Indris, Identifying the redox activity of cation-disordered Li—Fe—V—Ti oxide cathodes for Li-ion batteries, Phys. Chem. Chem. Phys. 18 (11)(2016) 7695-7701.
[17] W. H. Kan, D. Chen, J. K. Papp, A. K. Shukla, A. Huq, C. M. Brown, B. D. McCloskey, G. Chen, Unravelling solid-state redox chemistry in Li_{1.3}Nb_{0.3}Mn_{0.4}O₂ single-crystal cathode material, Chem. Mater. 30 (5)(2018) 1655-1666.
[18] H. Ji, D. A. Kitchaev, Z. Lun, H. Kim, E. Foley, D. H. Kwon, Y. Tian, M. Balasubramanian, M. Bianchini, Z. Cai, R. J. Clément, J. C. Kim, G. Ceder, Computational investigation and experimental realization of disordered high-capacity Li-ion cathodes based on Ni redox, Chem. Mater. 31 (7)(2019) 2431-2442.
[19] W. D. Richards, S. T. Dacek, D. A. Kitchaev, G. Ceder, Fluorination of lithium-excess transition metal oxide cathode materials, Adv. Energy Mater. 8 (5)(2018) 1701533.
[20] A. Sakuda, T. Takeuchi, K. Okamura, H. Kobayashi, H. Sakaebe, K. Tatsumi, Z. Ogumi, Rock-salt-type lithium metal sulphides as novel positive-electrode materials, Sci. Rep. 4 (2014) 4883.
[21] N. Yabuuchi, M. Takeuchi, M. Nakayama, H. Shiiba, M. Ogawa, K. Nakayama, T. Ohta, D. Endo, T. Ozaki, T. Inamasu, K. Sato, S. Komaba, High-capacity electrode materials for rechargeable lithium batteries: Li₃NbO₄-based system with cation-disordered rocksalt structure, Proc. Natl. Acad. Sci. U.S.A 112 (25)(2015) 7650-7655.
[22] S. Ren, R. Chen, E. Maawad, O. Dolotko, A. A. Guda, V. Shapovalov, D. Wang, H. Hahn, M. Fichtner, Improved voltage and cycling for Li⁺ intercalation in high-capacity disordered oxyfluoride cathodes, Adv. Sci. 2 (10)(2015) 1500128.
[23] A. Urban, A. Abdellahi, S. Dacek, N. Artrith, G. Ceder, Electronic-structure origin of cation disorder in transition-metal oxides, Phys. Rev. Lett. 119 (17)(2017) 176402.
[24] Z. Lun, B. Ouyang, D. A. Kitchaev, R. J. Clément, J. K. Papp, M. Balasubramanian, Y. Tian, T. Lei, T. Shi, B. D. McCloskey, J. Lee, G. Ceder, Improved cycling performance of Li-excess cation-disordered cathode materials upon fluorine substitution, Adv. Energy Mater. 9 (2)(2019) 1802959.
[25] E. Zhao, L. He, B. Wang, X. Li, J. Zhang, Y. Wu, J. Chen, S. Zhang, T. Liang, Y. Chen, X. Yu, H. Li, L. Chen, X. Huang, H. Chen, F. Wang, Structural and mechanistic revelations on high capacity cation-disordered Li-rich oxides for rechargeable Li-ion batteries, Energy Storage Mater. 16 (2019) 354-363.
[26] R. Chen, S. Ren, M. Knapp, D. Wang, R. Witter, M. Fichtner, H. Hahn, Disordered lithium-rich oxyfluoride as a stable host for enhanced Li⁺ intercalation storage, Adv. Energy Mater. 5 (9)(2015) 1401814.
[27] M. Freire, N. V. Kosova, C. Jordy, D. Chateigner, O. I. Lebedev, A. Maignan, V. Pralong, A new active Li—Mn—O compound for high energy density Li-ion batteries, Nat. Mater. 15 (2)(2016) 173-177.
[28] D. Chen, W. H. Kan, G. Chen, Understanding performance degradation in cation-disordered rock-salt oxide cathodes, Adv. Energy Mater. 9 (2019) 1901255.
[29] K. Luo, M. R. Roberts, R. Hao, N. Guerrini, D. M. Pickup, Y. S. Liu, K. Edström, J. Guo, A. V. Chadwick, L. C. Duda, P. G. Bruce, Charge-compensation in 3d-transition-metal-oxide intercalation cathodes through the generation of localized electron holes on oxygen, Nat. Chem. 8 (7)(2016) 684-691.
[30] N. Yabuuchi, M. Nakayama, M. Takeuchi, S. Komaba, Y. Hashimoto, T. Mukai, H. Shiiba, K. Sato, Y. Kobayashi, A. Nakao, M. Yonemura, K. Yamanaka, K. Mitsuhara, T. Ohta, Origin of stabilization and destabilization in solid-state redox reaction of oxide ions for lithium-ion batteries, Nat. Commun. 7 (2016) 13814.
[31] D. H. Seo, J. Lee, A. Urban, R. Malik, S. Kang, G. Ceder, The structural and chemical origin of the oxygen redox activity in layered and cation-disordered Li-excess cathode materials, Nat. Chem. 8 (7)(2016) 692-697.
[32] J. Lee, J. K. Papp, R. J. Clement, S. Sallis, D. H. Kwon, T. Shi, W. Yang, B. D. McCloskey, G. Ceder, Mitigating oxygen loss to improve the cycling performance of high capacity cation-disordered cathode materials, Nat. Commun. 8 (1)(2017) 981.
[33] J. Lee, D. H. Seo, M. Balasubramanian, N. Twu, X. Li, G. Ceder, A new class of high capacity cation-disordered oxides for rechargeable lithium batteries: Li—Ni—Ti−Mo oxides, Energy Environ. Sci. 8 (11)(2015) 3255-3265.
[34] H. Koga, L. Croguennec, M. Menetrier, K. Douhil, S. Belin, L. Bourgeois, E. Suard, F. Weill, C. Delmas, Reversible oxygen participation to the redox processes revealed for Li_{1.20}Mn_{0.54}Co_{0.13}Ni_{0.13}O₂, J. Electrochem. Soc. 160 (6)(2013) A786-A792.
[35] J. Neuefeind. M. Feygenson, J. Carruth, R. Hoffmann, K. K. Chipley, The Nanoscale Ordered MAterials Diffractometer NOMAD at the Spallation Neutron Source SNS, Nucl. Instruments Methods Phys. Res. Sect. B Beam Interact. with Mater. Atoms. 287 (2012) 68-75.
[36] F. Farges, G. E. Brown, Ti-edge XANES studies of Ti coordination and disorder in oxide compounds: Comparison between theory and experiment, Phys. Rev. B-Condens. Matter Mater. Phys. 56 (4)(1997) 1809-1819.
[37] H. Modrow, S. Bucher, J. J. Rehr, A. L. Ankudinov, Calculation and interpretation of K-shell x-ray absorption near-edge structure of transition metal oxides, Phys. Rev. B-Condens. Matter Mater. Phys. 67 (3)(2003) 035123.
[38] M. R. Li, Z. Deng, S. H. Lapidus, P. W. Stephens, C. U. Segre, M. Croft, R. Paria Sena, J. Hadermann, D. Walker, M. Greenblatt, Ba₃(Cr_{0.97}(1)Te_{0.03}(1))₂TeO₉: In search of Jahn-Teller distorted Cr (Il) oxide, Inorg. Chem. 55 (20)(2016) 10135-10142.
[39] Y. Lyu, L. Ben, Y. Sun, D. Tang, K. Xu, L. Gu, R. Xiao, H. Li, L. Chen, X. Huang, Atomic insight into electrochemical inactivity of lithium chromate (LiCrO₂): Irreversible migration of chromium into lithium layers in surface regions, J. Power Sources 273 (2015) 1218-1225.
[40] J. H. Dai, Q. Zhao, Q. Sun, S. Zhang, X. Wang, X. D. Shen, Z. H. Liu, X. Shen, R. C. Yu, T. S. Chan, L. X. Li, G. H. Zhou, Y. F. Yang, C. Q. Jin, Y. W. Long, Formation of unusual Cr⁵⁺ charge state in CaCr_{0.5}Fe_{0.5}O₃ perovskite, Chinese Physics B 27 (3) (2018) 037503.
[41] Z. Xia, H. Zhang, K. Shen, Y. Qu, Z. Jiang, Wavelet analysis of extended X-ray absorption fine structure data: Theory, application, Phys. B Condens. Matter. 542 (2018) 12-19.
[42] C. Mikutta, R. Kretzschmar, Spectroscopic evidence for ternary complex formation between arsenate and ferric iron complexes of humic substances, Environ. Sci. Technol. 45 (22)(2011) 9550-9557.
[43] M. D. De Jonge, S. Vogt, Hard X-ray fluorescence tomography—an emerging tool for structural visualization, Curr. Opin. Struct. Biol. 20 (5)(2010) 606-614.
[44] J. Rodríguez-Carvajal, G. Rousse, C. Masquelier, M. Hervieu, Electronic crystallization in a lithium battery material: Columnar ordering of electrons and holes in the spinel LiMn₂O₄, Phys. Rev. Lett. 81 (21)(1998) 4660-4663.
[45] W. S. Yoon, C. P. Grey, M. Balasubramanian, X. Q. Yang, J. McBreen, In situ X-ray absorption spectroscopic study on LiNi_{0.5}Mn_{0.5}O₂ cathode material during electrochemical cycling, Chem. Mater. 15 (16)(2003) 3161-3169.
[46] Y. Terada, K. Yasaka, F. Nishikawa, T. Konishi, M. Yoshio, I. Nakai, In situ XAFS analysis of Li (Mn, M)₂O₄ (M=Cr, Co, Ni) 5 V cathode materials for lithium-ion secondary batteries, J. Solid State Chem. 156 (2)(2001) 286-291.
[47] Z. Li, F. Du, X. Bie, D. Zhang, Y. Cai, X. Cui, C. Wang, G. Chen, Y. Wei, Electrochemical kinetics of the Li[Li_{0.23}Co_{0.3}Mn_{0.47}]O₂ cathode material studied by GITT and EIS, J. Phys. Chem. C. 114 (51)(2010) 22751-22757.
[48] S. Li, S.-J. Lee, X. Wang, W. Yang, H. Huang, D. S. Swetz, W. B. Doriese, G. C. O'Neil, J. N. Ullom, C. J. Titus, K. D. Irwin, H.-K. Lee, D. Nordlund, P. Pianetta, C. Yu, J. Qiu, X. Yu, X.-Q. Yang, E. Hu, J.-S. Lee, Y. Liu, Surface-to-bulk redox coupling through thermally driven Li redistribution in Li- and Mn-rich layered cathode materials, J. Am. Chem. Soc. 141 (30)(2019) 12079-12086.
[49] L. Tao, Z. Xu, C. Kuai, X. Zheng, C. E. Wall, C. Jiang, A. R. Esker, Z. Zheng, F. Lin, Flexible lignin carbon membranes with surface ozonolysis to host lean lithium metal anodes for nickel-rich layered oxide batteries, Energy Storage Mater. 24 (2019) 129-137.
[50] G. Assat, D. Foix, C. Delacourt, A. ladecola, R. Dedryvère, J. M. Tarascon, Fundamental interplay between anionic/cationic redox governing the kinetics and thermodynamics of lithium-rich cathodes, Nat. Commun. 8 (1)(2017) 2219.
[51] M. Munoz, P. Argoul, F. Farges, Continuous cauchy wavelet transform analyses of EXAFS spectra: A qualitative approach, Am. Mineral. 88 (4)(2003) 694-700.
[52] J. Timoshenko, A. Kuzmin, Wavelet data analysis of EXAFS spectra, Comput. Phys. Commun. 180 (6)(2009) 920-925.
[53] J. N. Zhang, Q. Li, C. Ouyang, X. Yu, M. Ge, X. Huang, E. Hu, C. Ma, S. Li, R. Xiao, W. Yang, Y. Chu, Y. Liu, H. Yu, X. Q. Yang, X. Huang, L. Chen, H. Li, Trace doping of multiple elements enables stable battery cycling of LiCoO₂ at 4.6 V, Nat. Energy. 4 (7)(2019) 594-603.
[54] J. Xu, M. Sun, R. Qiao, S. E. Renfrew, L. Ma, T. Wu, S. Hwang, D. Nordlund, D. Su, K. Amine, J. Lu, B. D. McCloskey, W. Yang, W. Tong, Elucidating anionic oxygen activity in lithium-rich layered oxides, Nat. Commun. 9 (1)(2018) 947.
[55] Z. W. Lebens-Higgins, N. V. Faenza, M. D. Radin, H. Liu, S. Sallis, J. Rana, J. Vinckeviciute, P. J. Reeves, M. J. Zuba, F. Badway, N. Pereira, K. W. Chapman, T.-L. Lee, T. Wu, C. P. Grey, B. C. Melot, A. Van Der Ven, G. G. Amatucci, W. Yang, L. F. J. Piper, Revisiting the charge compensation mechanisms in LiNi_{0.8}Co_{0.2y}Al_{y}O₂ systems, Mater. Horizons. 6 (2019) 2112-2123.
[56] D. Liu, Z. Shadike, R. Lin, K. Qian, H. Li, K. Li, S. Wang, Q. Yu, M. Liu, S. Ganapathy, X. Qin, Q. H. Yang, M. Wagemaker, F. Kang, X. Q. Yang, B. Li, Review of recent development of in situ/operando characterization techniques for lithium battery research, Adv. Mater. 31 (2019) 1806620.
[57] L. Mu, R. Lin, R. Xu, L. Han, S. Xia, D. Sokaras, J. D. Steiner, T. C. Weng, D. Nordlund, M. M. Doeff, Y. Liu, K. Zhao, H. L. Xin, F. Lin, Oxygen release induced chemomechanical breakdown of layered cathode materials, Nano Lett. 18 (5)(2018) 3241-3249.
[58] F. Lin, I. M. Markus, D. Nordlund, T. C. Weng, M. D. Asta, H. L. Xin, M. M. Doeff, Surface reconstruction and chemical evolution of stoichiometric layered cathode materials for lithium-ion batteries, Nat. Commun. 5 (2014) 3529.
[59] J. Hong, H. D. Lim, M. Lee, S. W. Kim, H. Kim, S. T. Oh, G. C. Chung, K. Kang, Critical role of oxygen evolved from layered Li-Excess metal oxides in lithium rechargeable batteries, Chem. Mater. 24 (14)(2012) 2692-2697.
[60] L. Mu, X. Feng, R. Kou, Y. Zhang, H. Guo, C. Tian, C. J. Sun, X. W. Du, D. Nordlund, H. L. Xin, F. Lin, Deciphering the cathode-electrolyte interfacial chemistry in sodium layered cathode materials, Adv. Energy Mater. 8 (34)(2018) 1801975.
[61] N. Takeda, I. Ikeuchi, R. Natsui, K. Nakura, N. Yabuuchi, Improved electrode performance of lithium-excess molybdenum oxyfluoride: Titanium substitution with concentrated electrolyte, ACS Appl. Energy Mater. 2 (2019) 1629-1633.
[62] B. Huang, R. Wang, Y. Gong, B. He, H. Wang, Enhanced cycling stability of cation disordered rock-salt Li_{1.2}Ti_{0.4}Mn_{0.4}O₂ material by surface modification with Al₂O₃, Front. Chem. 7 (2019) 107.
[63] M. Murase, J. F. Watts, XPS study of coating delamination from non-rinse chromate treated steel, J. Mater. Chem. 8 (4)(1998) 1007-1018.
[64] J. P. Lafleur, E. D. Salin, Speciation of chromium by high-performance thin-layer chromatography with direct determination by laser ablation inductively coupled plasma mass spectrometry, Anal. Chem. 80 (17)(2008) 6821-6823.
[65] F. Zhou, M. Cococcioni, C. A. Marianetti, D. Morgan, G. Ceder, First-principles prediction of redox potentials in transition-metal compounds with LDA+U, Phys. Rev. B-Condens. Matter Mater. Phys. 70 (23)(2004) 235121.
[66] C. Liu, Z. G. Neale, G. Cao, Understanding electrochemical potentials of cathode materials in rechargeable batteries, Mater. Today. 19 (2)(2016) 109-123.
[67] D. A. Kuznetsov, B. Han, Y. Yu, R. R. Rao, J. Hwang, Y. Román-Leshkov, Y. Shao-Horn, Tuning redox transitions via inductive effect in metal oxides and complexes, and implications in oxygen electrocatalysis, Joule. 2 (2)(2018) 225-244.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A Group I metal cation excess cathode material comprising a Group I metal cation, at least two different non-Group I metal cations, and at least one counterion;
wherein at least one of the at least two different non-Group I metal cations has a redox reaction within a voltage window of about 1.5 V to about 5.0 V vs Li/Li⁺ when measured according to the Redox Potential Measurement Method;
wherein the cathode material has an original specific capacity measured according to the Specific Capacity Test of about 100 mAh to about 300 mAh per g of the cathode material; and
wherein a percentage of the original specific capacity attributable to the at least two different non-Group I metal cations as determined by the Specific Capacity Deconvolution Procedure is from about 50% to about 100%; and
with the proviso that the material is not Li_{1.15}Ni_{0.45}Ti_{0.3}Mo_{0.1}O_{1.85}F_{0.15} or Li_{1.2}Mn_{0.6}Nb_{0.2}O_{1.9}F_{0.1}.

2. The cathode material according to claim 1, wherein the Group I metal cation is selected from the group consisting of a Li cation, a Na cation, a K cation, and a combination thereof.

3. The cathode material according to claim 1, wherein the Group-I metal cation is a Li cation.

4. The cathode material according to claim 1, wherein the at least two different non-Group I metal cations are each independently selected from the group consisting of Sc, Ti, V, Cr, Mn, Fe, Co, Ni, Cu, Zn, Y, Zr, Nb, Mo, Tc, Ru, Rh, Ag, Cd, La, Ce, Hf, Ta, W, Re, Os, Ir, Pt, Au, Hg, Be, Mg, Ca, Sr, Ba, B, Al, Ga, In, Si, Ge, Sn, Pb, Sb, Bi, Se, and Te cations.

5. (canceled)

6. (canceled)

7. The cathode material according to claim 1, wherein the Group I metal cation excess salt has a composition according to the formula AᵥM_{w}¹Mₓ²O_{y}D_{z} in the uncharged state;
where A is a Group I metal;
where M¹ and M² are each different non-Group I metal cations;
where D is selected from the group consisting of Fl, Cl, and Br;
where v is a number from 0 to 3;
where w is a number from 0 to 2;
where x is a number from 0 to 2;
where y is a number from 1 to 2;
where z is a number from 0 to 2;
where v+q¹*w+q²*x=2*y+z;
where q¹ and q² are the positive oxidation states of M¹ and M² respectively.

8. The cathode material according to claim 7, wherein q¹ and q² are each +3.

9. (canceled)

10. The cathode material according to claim 1, wherein the Group I metal cation excess salt has a composition according to the formula AᵥM_{w}¹Mₓ²M³ O_{y}D_{z} in the uncharged state;
where A is a Group I metal;
where M¹ and M² and M³ are each different non-Group I metals;
where D is selected from the group consisting of Fl, Cl, and Br;
where v is a number from 0 to 3;
where w is a number from 0 to 2;
where x is a number from 0 to 2;
where u is a number from 0 to 2
where y is a number from 1 to 2;
where z is a number from 0 to 2;
where v+q¹·w+q²·x+q³·u=2*y+z;
where q¹ and q² and q³ are the positive oxidation states of M¹ and M² and M³ respectively.

11. The cathode material according to claim 10, wherein q¹ and q² and q³ are each +3.

12. (canceled)

13. The cathode material according to claim 1, wherein the cathode material has a disordered cubic crystal structure surrounded by amorphous structure.

14. (canceled)

15. (canceled)

16. The cathode material according to claim 1, wherein the cathode material has a specific capacity measured after a number of cycles that is from 60% to 90% of the original specific capacity when measured according to the Specific Capacity Test, and wherein the number of cycles is from 200 to 5,000 cycles.

17. The cathode material according to claim 1, wherein there is substantially no phase separation of the material as determined by X-ray diffraction after 1,000 charge-discharge cycles according to the Galvanostatic Cycling Test; wherein substantially no phase separation means the cubic lattice peak structure is maintained as measured by X-ray diffraction pattern wherein there is no new peak forming in the X-ray diffraction after the Galvanostatic Cycling Test.

18. The cathode material according to claim 1, wherein a percentage of the original specific capacity attributable to a reversible oxygen redox process is from 0% to 50%, or from 0% to 40%, or from 0% to 30%, or from 0% to 20%, or from 0% to 10%, as defined as the difference between the original specific capacity and a specific capacity of the non-Group I metal cations as measured by the Specific Capacity Deconvolution Procedure.

19. (canceled)

20. (canceled)

21. The cathode material according to claim 1, wherein one of the at least two different non-Group I metal cations is a Cr cation.

22. The cathode material according to claim 1, wherein one of the at least two different non-Group I metal cations is a Mn cation.

23. (canceled)

24. The cathode material according to claim 1, wherein one of the at least two different non-Group I metal cations is an Al cation.

25. The cathode material according to claim 1, wherein one of the at least two different non-Group I metal cations is an Fe cation.

26. (canceled)

27. The cathode material according to claim 1, wherein two of the at least two different non-Group I metal cations are selected from the group consisting of Mn and Fe cations, Mn and V cations, Mn and Cr cations, Mn and Cu cations, Mn and W cations, Mn and Ni cations, and Mn and Co cations or from the group consisting of Mn and Fe cations, Mn and V cations, Mn and Cr cations, Mn and Cu cations, and Mn and W cations or from the group consisting of Fe and Co cations, Fe and Ni cations, Fe and Cu cations, Fe and W cations, and Fe and Cr cations.

28. (canceled)

29. (canceled)

30-48. (canceled)

49. The cathode material according to claim 1, wherein the at least one counterion is selected from the group consisting of F⁻, Cl⁻, and Br⁻.

50. The cathode material according to claim 1, wherein the at least one counterion is F⁻.

51-56. (canceled)

57. The cathode material according to claim 1, which has a specific capacity measured according to the Specific Capacity Test of from 50% to 90% of the original specific capacity after from 500 to 1000 cycles according to the Galvanostatic Cycling.

58-61. (canceled)

62. The cathode material according to claim 1, which has an original specific capacity of from about 150 to 300 mAh/g measured according to the Specific Capacity Test.

63. (canceled)

64. (canceled)

65. The cathode material of claim 1, wherein an average particle size of the cathode material is from 5 nm to 100 μm as determined by scanning electron microscopy and transmission electron microscopy.

66. The cathode material according to claim 1, which is selected from the group consisting of:
(i) Li_{1.3}Mn_{0.4}Nb_{0.3}O₂,
(ii) Li₂Mn_{3/4}Cr_{1/4}O₂F,
(iii) Li_{2.1}Mn_{0.75}Cr_{0.25}O_{2.05}F,
(iv) Li_{2.2} Mn_{0.75}Cr_{0.25}O_{2.1}F,
(v) Li_{2.1}Mn_{0.667}Nb_{0.333}O_{2.05}F
(vi) Li_{2.1} Mn_{0.5}Ti_{0.5}O_{2.05}F,
(vii) Li_{2.1} Mn_{0.45}Ti_{0.45}Al_{0.1}O_{2.05}F,
(viii) Li_{2.1}Mn_{0.45}Ti_{0.45}Fe_{0.1}O_{2.05}F,
(ix) Li₂Mn_{2/3}V_{1/3}O₂F and
(x) Li_{1.75}Mn_{0.45}Ti_{0.45}Fe_{0.1}O₂F_{0.75}, and
(xi) Li_{1.25}Mn_{0.45}Ti_{0.45}Fe_{0.1}O₂F_{0.25}.

67. (canceled)

68. The electrochemical device according to claim 67, further comprising:
(ii) an anode stack comprising an anodic current collector and an anode material that is formed over at least a portion of the anodic current collector;
(iii) a separator material between the cathode stack and the anode stack; and
(iv) an electrolyte;
wherein the electrochemical device is a battery.

69. The electrochemical device according to claim 68, wherein the anode material is selected from the group consisting of Graphite, Si, Li metal, Na metal, K metal, Sn, Graphite/Si composite, Graphite/Sn composite, Graphite/Li composite, Graphite/Na composite, Graphite/K composite, and hard carbon.

70. (canceled)

71. (canceled)

72. A method of making the Group I metal cation excess cathode material of claim 1, the method comprising:
(i) combining a salt, an oxide, and/or a peroxide of a Group I metal, a salt, an oxide, and/or a peroxide of a first non-Group I metal, and a salt, an oxide, and/or a peroxide of a second non-Group I metal to prepare a precursor;
(ii) ball milling the precursor to form a powder;
(iii) combining the powder with a molar excess of a flux material to form a mixture;
(iv) heating the mixture to an elevated temperature relative to room temperature for a period of time sufficient to form a calcined powder comprising the cathode material.

73-77. (canceled)

78. The method according to according to claim 72, wherein the flux material is selected from the group consisting of potassium chloride, LiCl, LiNO₃, LiOH, LiF, Li₂SO₄, Li₂CO₃, CH₃C(O)OLi, NaCl, NaNO₃, NaOH, Na₂SO₄, Na₂CO₃, CH₃C(O)ONa, NaF, KCl, KNO₃, KOH, K₂SO₄, K₂CO₃, CH₃C(O)OK and KF.

79-92. (canceled)

93. The use of the Group I metal cation excess cathode material according to claim 1 in an electrochemical cell.

94. The use of the Group I metal cation excess cathode material according to claim 1 in a battery.
